(19) United States
(12) Patent Application Publication
(10) Pub. No.: US 2026/0356116 A1
(43) Pub. Date: Nov. 12, 2026

(54) DISPLAY BODY

(71) Applicant: TOPPAN Holdings Inc., Tokyo (JP)

(72) Inventors: Masahiro YOKOO, Tokyo (JP); Yoshihiro KITA, Tokyo (JP)

(73) Assignee: TOPPAN Holdings Inc., Tokyo (JP)

(21) Appl. No.: 19/717,802

(22) Filed: Jun. 24, 2026

Related U.S. Application Data
(63) Continuation of application No. PCT/JP2024/045018, filed on Dec. 19, 2024.

(30) Foreign Application Priority Data
Dec. 25, 2023 (JP) 2023-217864

(51) Int. Cl. B42D 25/378; B42D 25/351

(52) U.S. Cl. CPC B42D 25/378; B42D 25/351

(57) ABSTRACT

Provided is a display technique enabling special image display. A display body includes a transparent material layer having a first major surface and a second major surface, a mask layer provided on the first major surface and having light transmitting portions regularly arranged, and an image display layer provided on the second major surface. The image display layer includes a first layer displaying a first color, and a second layer displaying a second color different from the first color, the first layer includes first portions arranged in an arrangement direction of the light transmitting portions at the same pitch as a pitch of the light transmitting portions in the arrangement direction, the second layer includes second portions alternately arranged with the first portions in the arrangement direction.

### CROSS-REFERENCE TO RELATED APPLICATIONS

This application claims benefit of priority to International Patent Application No. PCT/JP 2024/045018, filed Dec. 19, 2024, and to Japanese Patent Application No. 2023-217864, filed Dec. 25, 2023, the entire contents of each are incorporated herein by reference.

### BACKGROUND

### Technical Field

The present disclosure relates to a display technique.

### Background Art

In recent years, improved performance of digital devices such as scanners, printers, and color copiers allows easy production of precise duplicates of valuable printed matter. In order to prevent such duplication and counterfeiting, anti-counterfeiting technologies are needed. Among anti-counterfeiting technologies, in particular, there is a need for an anti-counterfeiting technology represented by watermarks, holograms, and the like that enables anyone who uses printed material to determine the authenticity without the need for tools.

Anti-counterfeiting technologies that enable determination of authenticity without the need for tools include an anti-counterfeiting technology using an optically variable ink containing a functional pigment whose color varies according to a change in light interference conditions, also referred to as an interference pigment. In an image displayed by a printed layer made of such an ink, color variation occurs due to a change in illumination direction or observation direction; thus, users can determine the authenticity of printed matter by checking color variation.

Representative examples of the optically variable ink include pearl ink and optical variable ink (OVI) used in banknotes and the like. The color of an image printed using the former changes, for example, from colorless to pink due to a change in illumination direction or observation direction. The color of an image printed using the latter changes, for example, from blue-green to purple or the like due to a change in illumination direction or observation direction.

The use of color variation in such an optically variable ink allows more complex color variation. For example, in JP 2014-83721 A, a plurality of first lines that contain an interference pigment and are regularly arranged in the width direction are provided so that a cross section of each of the first lines perpendicular to the longitudinal direction has a substantially semicircular shape, and a plurality of second lines that exhibit a color different from the color exhibited by the first lines under a condition in which specular reflection light is observed are provided on the first lines so that surfaces of the first lines are partially exposed. In printed matter obtained in this manner, a change in observation direction in a plane perpendicular to the longitudinal direction of the first lines causes a change in the ratio between the intensity of specular reflection light from the first lines and the intensity of specular reflection light from the second lines, leading to color variation in an image displayed by the lines. In the image, color variation due to the interference pigment may further occur.

### SUMMARY

An object of the present disclosure is to provide a display technique that enables special image display.

According to an aspect of the present disclosure, there is provided a display body including a transparent material layer that has a first major surface and a second major surface opposite to the first major surface; a mask layer that is provided on the first major surface and has a plurality of light transmitting portions regularly arranged; and an image display layer that is provided on the second major surface, in which the image display layer includes a first layer that displays a first color, and a second layer that displays a second color different from the first color. The first layer includes a plurality of first portions that are arranged in a first arrangement direction of the plurality of light transmitting portions at a same pitch as a pitch of the plurality of light transmitting portions in the first arrangement direction. The second layer includes a plurality of second portions that are alternately arranged with the plurality of first portions in the first arrangement direction, and each of the plurality of first portions and the plurality of second portions includes one or more first regions each of which is observable through one of the plurality of light transmitting portions as observed from a normal direction perpendicular to the first major surface, and one or more second regions that are unobservable through any of the plurality of light transmitting portions as observed from the normal direction.

According to another aspect of the present disclosure, there is provided the display body according to the above aspect, in which the mask layer has a light shielding property.

According to still another aspect of the present disclosure, there is provided the display body according to any of the above aspects, in which an aperture ratio of portions of the mask layer in which the plurality of light transmitting portions are provided is in a range of 10% to 90%.

According to still another aspect of the present disclosure, there is provided the display body according to any of the above aspects, in which a ratio S1/S2 between a total area S1 of the one or more first regions of all the plurality of first portions and the plurality of second portions and a total area S2 of the plurality of light transmitting portions is in a range of 10% to 100%.

According to still another aspect of the present disclosure, there is provided the display body according to any of the above aspects, in which the plurality of first portions are arranged in a same shape as the plurality of second portions.

According to still another aspect of the present disclosure, there is provided the display body according to any of the above aspects, in which the plurality of light transmitting portions each have a strip shape and are regularly arranged in a width direction, and each of the plurality of first portions and the plurality of second portions extends in a longitudinal direction of the plurality of light transmitting portions.

According to still another aspect of the present disclosure, there is provided the display body according to the above aspect, in which the plurality of light transmitting portions are arranged in a stripe pattern.

Alternatively, according to still another aspect of the present disclosure, there is provided the display body according to the above aspect, in which the plurality of light transmitting portions are arranged in a nested manner.

According to still another aspect of the present disclosure, there is provided the display body according to any of the above aspects, in which portions of the mask layer in which the plurality of light transmitting portions are provided are in a grid pattern.

According to still another aspect of the present disclosure, there is provided the display body according to the above aspect, in which each of the plurality of first portions and the plurality of second portions has a shape extending in a second arrangement direction of the plurality of light transmitting portions.

According to still another aspect of the present disclosure, there is provided the display body according to the above aspect, in which one side along a longitudinal direction of each of the plurality of first portions and the plurality of second portions has a wavy shape.

According to still another aspect of the present disclosure, there is provided the display body according to any of the above aspects, in which portions of the mask layer in which the plurality of light transmitting portions are provided are in a checkerboard pattern.

According to still another aspect of the present disclosure, there is provided the display body according to the above aspect, in which the plurality of first portions are arranged in a checkerboard pattern corresponding to the plurality of light transmitting portions, and the plurality of first portions and the plurality of second portions are alternately arranged in each of the first arrangement direction of the plurality of light transmitting portions and a second arrangement direction of the plurality of light transmitting portions.

According to still another aspect of the present disclosure, there is provided the display body according to any of the above aspects, further including a rear surface layer that faces the second major surface via the image display layer.

According to still another aspect of the present disclosure, there is provided the display body according to the above aspect, in which the rear surface layer is a reflective layer or is made of an ink containing a light reflecting pigment or light scattering pigment.

According to still another aspect of the present disclosure, there is provided the display body according to any of the above aspects, in which a maximum value Rpf1 of a reflectance of the plurality of first portions measured in a wavelength range of 400 to 700 nm through the light transmitting portions, an average value Raf1 of the reflectance of the plurality of first portions measured in the wavelength range of 400 to 700 nm through the light transmitting portions, a maximum value Rpf2 of a reflectance of the plurality of second portions measured in the wavelength range of 400 to 700 nm through the light transmitting portions, an average value Raf2 of the reflectance of the plurality of second portions measured in the wavelength range of 400 to 700 nm through the light transmitting portions, a maximum value Rpb of a reflectance of a surface of the rear surface layer facing away from the second major surface measured in the wavelength range of 400 to 700 nm, and an average value Rab of the reflectance of the surface of the rear surface layer facing away from the second major surface measured in the wavelength range of 400 to 700 nm satisfy relationships expressed in Formulas (1) to (5).

Raf1≥20% . . . (1)

Raf2≥20% . . . (2)

Rab≥30% . . . (3)

(Rpf1−Raf1)−(Rpb−Rab)≥10% . . . (4)

(Rpf2−Raf2)−(Rpb−Rab)≥10% . . . (5)

According to still another aspect of the present disclosure, there is provided the display body according to any of the above aspects, in which the mask layer is a black layer, a white layer, or a metal layer.

According to still another aspect of the present disclosure, there is provided the display body according to any of the above aspects, in which the mask layer includes a light shielding layer, and a colored layer that faces the first major surface via the light shielding layer.

According to still another aspect of the present disclosure, there is provided a label including: the display body according to any of the above aspects; and an adhesive layer that faces the second major surface via the image display layer.

According to still another aspect of the present disclosure, there is provided an article with display body including the display body according to any of the above aspects; and an article that supports the display body.

According to still another aspect of the present disclosure, there is provided the article with display body according to the above aspect, in which the article has a support surface, the display body is supported by the article so that the second major surface faces the support surface via the image display layer, and a color difference ΔE*_{ab} between the mask layer and the support surface is 5 or less.

### BRIEF DESCRIPTION OF THE DRAWINGS

FIG. 1 is a top view of a display body according to a first embodiment of the present disclosure.

FIG. 2 is a cross-sectional view of the display body taken along the line II-II in FIG. 1.

FIG. 3 is a schematic diagram illustrating a state in which an image displayed by the display body shown in FIGS. 1 and 2 under a given observation condition is observed by an observer.

FIG. 4 is an enlarged view of the image displayed by the display body in FIGS. 1 and 2 under the observation condition in FIG. 3.

FIG. 5 is a schematic diagram illustrating a state in which an image displayed by the display body shown in FIGS. 1 and 2 under another observation condition is observed by an observer.

FIG. 6 is an enlarged view of the image displayed by the display body in FIGS. 1 and 2 under the observation condition in FIG. 5.

FIG. 7 is a schematic diagram illustrating a state in which an image displayed by the display body shown in FIGS. 1 and 2 under still another observation condition is observed by an observer.

FIG. 8 is an enlarged view of the image displayed by the display body in FIGS. 1 and 2 under the observation condition in FIG. 7.

FIG. 9 is a schematic diagram illustrating a state in which an image displayed by the display body shown in FIGS. 1 and 2 under still another observation condition is observed by an observer.

FIG. 10 is an enlarged view of the image displayed by the display body in FIGS. 1 and 2 under the observation condition in FIG. 9.

FIG. 11 is a schematic diagram illustrating a state in which an image displayed by the display body shown in FIGS. 1 and 2 under still another observation condition is observed by an observer.

FIG. 12 is an enlarged view of the image displayed by the display body in FIGS. 1 and 2 under the observation condition in FIG. 11.

FIG. 13 is an enlarged view of an image displayed by a display body according to a second embodiment of the present disclosure under a given observation condition.

FIG. 14 is a diagram illustrating a structure obtained by omitting a mask layer from the display body in FIG. 13.

FIG. 15 is an enlarged view of an image displayed by a display body according to a third embodiment of the present disclosure under a given observation condition.

FIG. 16 is a diagram illustrating a structure obtained by omitting a mask layer from the display body in FIG. 15.

FIG. 17 is an enlarged view of an image displayed by a display body according to a fourth embodiment of the present disclosure under a given observation condition.

FIG. 18 is a diagram illustrating a structure obtained by omitting a mask layer from the display body in FIG. 17.

FIG. 19 is a cross-sectional view of a display body according to a fifth embodiment of the present disclosure.

FIG. 20 is a cross-sectional view of a display body according to a sixth embodiment of the present disclosure.

FIG. 21 is a cross-sectional view of a label according to a seventh embodiment of the present disclosure.

FIG. 22 is a cross-sectional view of an article with a display body according to an eighth embodiment of the present disclosure.

FIG. 23 is a cross-sectional view of an article with a display body according to a ninth embodiment of the present disclosure.

FIG. 24 is a schematic diagram illustrating a state in which an image displayed by a display body according to a tenth embodiment of the present disclosure under a given observation condition is observed by an observer.

FIG. 25 is a cross-sectional view of a first step of a printing method used in examples.

FIG. 26 is a cross-sectional view of a second step of the printing method used in the examples.

FIG. 27 is a cross-sectional view of a third step of the printing method used in the examples.

### DETAILED DESCRIPTION

Embodiments of the present disclosure will be described with reference to the drawings. The embodiments described below are embodiments of the aspects described above. The matters described below can be incorporated into each of the aspects, either alone or in combination.

The embodiments described below are example configurations for embodying the technical idea of the present disclosure, and the technical idea of the present disclosure is not limited to the materials, shapes, structures, or the like of the components described below. Various modifications can be made to the technical idea of the present disclosure within the technical scope defined by the claims.

It should be noted that components having the same or similar functions are denoted by the same reference signs in the drawings referred to below, and redundant description is omitted. In addition, the drawings are schematic, and the relationship between dimensions in one direction and another direction, the relationship between dimensions of a member and another member, and the like may be different from the actual relationship.

### First Embodiment

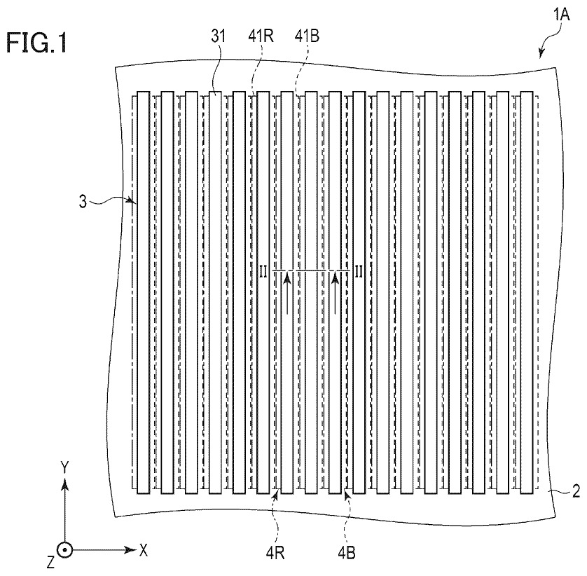

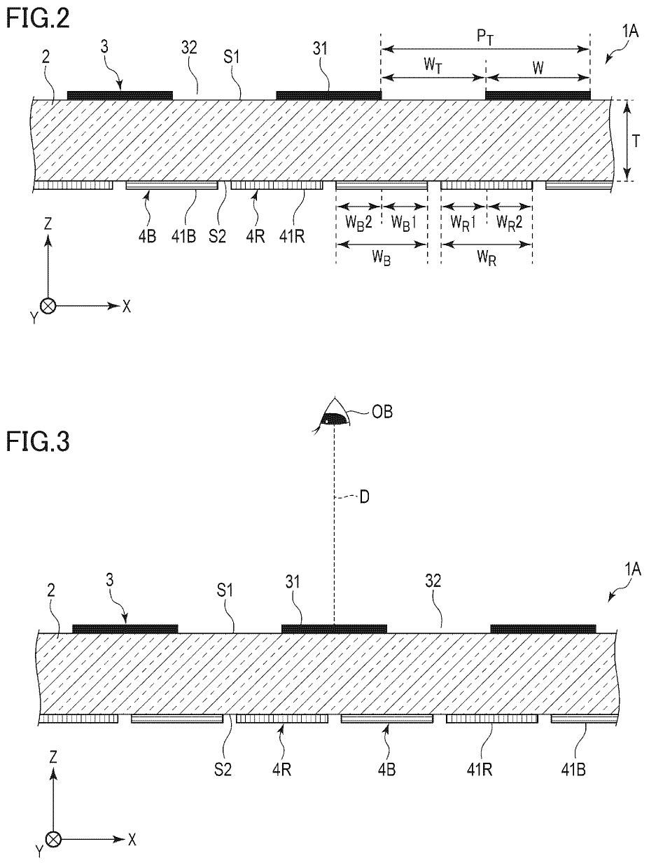

FIG. 1 is a top view of a display body according to a first embodiment of the present disclosure. FIG. 2 is a cross-sectional view of the display body taken along the line II-II in FIG. 1.

In the figures, the X direction is a direction parallel to a first major surface of a transparent material layer (described later), that is, a direction parallel to a display surface of the display body. The Y direction is a direction parallel to the first major surface and perpendicular to the X direction, that is, a direction parallel to the display surface and perpendicular to the X direction. The Z direction is a direction perpendicular to the X direction and the Y direction, that is, the thickness direction of the display body.

A display body 1A shown in FIGS. 1 and 2 includes a transparent material layer 2, a mask layer 3, and an image display layer.

The transparent material layer 2 is a layer made of a material transparent to light in the visible range. The transparent material layer 2 is preferably colorless and transparent.

The transparent material layer 2 is a substrate that supports the mask layer 3 and the image display layer. The transparent material layer 2 may be a soft substrate such as a sheet or a film, or a hard substrate such as a card. The transparent material layer 2 may have a single-layer structure or a multilayer structure.

The material of the transparent material layer 2 may be an inorganic material such as glass, or an organic material such as a polymer. The organic material such as a polymer may be, for example, a photocurable resin such as a polycarbonate resin, an acrylic resin, a fluorine acrylic resin, a silicone acrylic resin, an epoxy acrylate resin, a polystyrene resin, a cycloolefin polymer, a methylstyrene resin, a fluorene resin, polyethylene terephthalate (PET), or polypropylene; a thermosetting resin such as an acrylonitrile-styrene copolymer resin, a phenol resin, a melamine resin, a urea resin, or an alkyd resin; or a thermoplastic resin such as a polypropylene resin, a polyethylene terephthalate resin, or a polyacetal resin.

A thickness T of the transparent material layer 2 is preferably 30 μm or more, and more preferably 50 μm or more. When the thickness T of the transparent material layer 2 is small, for example, less than 30 μm, the display body 1A has low strength. Furthermore, when the thickness T of the transparent material layer 2 is small, for example, less than 30 μm, a large change in observation direction is required to cause great color variation in an image displayed by the display body 1A.

The thickness T of the transparent material layer 2 is preferably 200 μm or less, more preferably 150 μm or less, and even more preferably 100 μm or less. When the thickness T of the transparent material layer 2 is large, for example, greater than 200 μm, a slight change in observation direction can cause great color variation in an image displayed by the display body 1A.

As shown in FIG. 2, the transparent material layer 2 has a first major surface S1, and a second major surface S2 opposite to the first major surface S1. The first major surface S1 and the second major surface S2 here are planes parallel to each other.

The mask layer 3 is provided on the first major surface S1. The mask layer 3 is composed of a plurality of mask portions 31 each of which extends in the Y direction and that are arranged in the X direction. The mask portions 31 have the same width, are separated from each other, and are arranged at a constant pitch P_{T} in the X direction.

The mask portions 31 make it impossible or difficult to visually recognize the color of portions of the image display layer concealed by the mask portions 31. In one example, the mask layer 3 has a light shielding property. In another example, the mask portions 31 of the mask layer 3 are opaque. The mask portions 31 may have a light absorbing property, a light scattering property, or a light reflecting property for light in the visible range. The mask portions 31 preferably have a visible light transmittance of 70% or less, and more preferably 50% or less. The “visible light transmittance” is an average transmittance in the wavelength range of 400 to 700 nm. The visible light transmittance can be obtained by measuring the transmittance using an LVmicro-Z manufactured by Lambda Vision.

The mask portions 31 may be, for example, colorless. The mask layer 3 may be, for example, a colorless layer. The colorless mask layer 3 may be, for example, a light shielding layer selected from a black layer, a white layer, and a metal layer.

The mask portions 31 may be colored. That is, the mask layer 3 may be a colored layer. The color of the colored mask portions 31 and the colored mask layer 3 may be any color, but is preferably a color that can be obtained by mixing a first color displayed by a first layer 4B and a second color displayed by a second layer 4R.

Here, as an example, the color of the mask portions 31 is assumed to be black. That is, the color of the mask layer 3 is assumed to be black.

The height of the mask portions 31, that is, the thickness of the mask layer 3 is, for example, in the range of 0.1 to 10 μm. The thickness of the mask layer 3 is preferably 0.2 μm or more. When the mask portions 31 have a small height, for example, less than 0.1 μm, the mask layer 3 may have low concealability. When the mask portions 31 has a large height, for example, greater than 10 μm, it is difficult for the mask portions 31 to have a small width W.

The mask layer 3 has a plurality of light transmitting portions 32 that are regularly arranged. The light transmitting portions 32 have a higher transmittance in the visible range than the mask portions 31.

The light transmitting portions 32 here are openings provided in the mask layer 3. The light transmitting portions 32 may be transparent portions that are made of a transparent material embedded in openings provided in the mask layer 3. The transparent portions are preferably colorless and transparent.

The light transmitting portions 32 here each have a strip shape, and are regularly arranged in the width direction. Specifically, the light transmitting portions 32 each extend in the Y direction, and are arranged in the X direction. The light transmitting portions 32 have the same width W_{T}, and are arranged at the constant pitch P_{T} in the X direction. That is, the light transmitting portions 32 here are arranged in a stripe pattern.

The width W_{T} of the light transmitting portions 32 is preferably 20 μm or more, and more preferably 25 μm or more. When the width W_{T} is small, for example, less than 20 μm, the color of an image displayed by the display body 1A is less influenced by the image display layer.

The width W_{T} of the light transmitting portions 32 is preferably 100 μm or less. When the width W_{T} is large, for example, greater than 100 μm, in an image displayed by the display body 1A, small color variation occurs according to a change in observation direction.

The arrangement pitch P_{T} of the light transmitting portions 32 is preferably 50 μm or more, and more preferably 80 μm or more. When the pitch P_{T} is small, for example, less than 50 μm, first portions 41B and second portions 41R (described later) need to have a smaller width.

The pitch P_{T} is preferably 250 μm or less. When the pitch P_{T} is large, for example, greater than 250 μm, particularly in a case where the mask portions 31 have a large width, each of the mask portions 31 can be identified by observation with the naked eye.

The aperture ratio of portions of the mask layer 3 in which the light transmitting portions 32 are provided is preferably in the range of 10% to 90%. In one example, the aperture ratio is preferably in the range of 40% to 70%, and more preferably in the range of 50% to 60%. In another example, the aperture ratio is preferably in the range of 70% to 90%, and more preferably in the range of 80% to 85%. When the aperture ratio is high, for example, in a range of 70% to 90%, for example, the display body 1A can display an image with high saturation and brightness. For example, in an integrated object obtained by sandwiching the display body 1A between a pair of substrates, a high aperture ratio leads to high adhesion between the substrate on the front surface side and the display body 1A, and facilitates visual recognition of an image recorded on the substrate on the rear surface side in regions corresponding to the portions of the mask layer 3 in which the light transmitting portions 32 are provided. However, when the aperture ratio is high, for example, greater than 90%, in an image displayed by the display body 1A, small color variation may occur due to a change in observation direction. The aperture ratio here is a ratio W_{T}/P_{T} between the width W_{T} and the pitch P_{T}.

The image display layer is provided on the second major surface S2. The image display layer includes the first layer 4B and the second layer 4R.

The first layer 4B displays the first color. Here, as an example, the first layer 4B is assumed to display blue.

The first layer 4B includes the plurality of first portions 41B. Each of the first portions 41B includes one or more first regions each of which is observable through one of the light transmitting portions 32 as observed from a normal direction perpendicular to the first major surface S1, hereinafter referred to as a first direction, and one or more second regions that are unobservable through any of the light transmitting portions 32 as observed from the first direction.

The first portions 41B here each extend in the Y direction, and are arranged in the X direction. The first portions 41B have, as a first region, a region facing one of the light transmitting portions 32 via the transparent material layer 2, and have, as a second region, a region facing one of the mask portions 31 via the transparent material layer 2. The one or more first regions and the one or more second regions each have a shape extending in the longitudinal direction of the light transmitting portions 32, and are arranged in the width direction of the light transmitting portions 32.

The second layer 4R displays a second color different from the first color. Here, as an example, the second layer 4R is assumed to display red.

The second layer 4R includes the plurality of second portions 41R. Each of the second portions 41R includes one or more first regions each of which is observable through one of the light transmitting portions 32 as observed from the first direction, and one or more second regions that are unobservable through any of the light transmitting portions 32 as observed from the first direction.

The second portions 41R here each extend in the Y direction, and are arranged in the X direction. The second portions 41R have, as a first region, a region facing one of the light transmitting portions 32 via the transparent material layer 2, and have, as a second region, a region facing one of the mask portions 31 via the transparent material layer 2. The one or more first regions and the one or more second regions each have a shape extending in the longitudinal direction of the light transmitting portions 32, and are arranged in the width direction of the light transmitting portions 32.

The first portions 41B and the second portions 41R are alternately arranged in an arrangement direction such as a first arrangement direction of the light transmitting portions 32. The arrangement pitch of the first portions 41B and the arrangement pitch of the second portions 41R are the same as the arrangement pitch P_{T} of the light transmitting portions 32. The first portions 41B and the second portions 41R are arranged so that the positions of boundary regions between the first portions 41B and the second portions 41R coincide with the positions of center lines of the mask portions 31 or the positions of center lines of the light transmitting portions 32.

The first portions 41B are arranged in the same shape as the second portions 41R. The arrangement positions of the first portions 41B match the arrangement positions of the second portions 41R in the Y direction. The first portions 41B and the second portions 41R here are arranged in a rectangular shape.

The first portions 41B and the second portions 41R are separated from each other. If variation in the shape or size of the first portions 41B and the second portions 41R causes the first portions 41B and the second portions 41R to be partially overlapped with each other at the positions of the light transmitting portions 32, the areas of the regions of the first portions 41B and the second portions 41R observable through the light transmitting portions 32 deviate from the design values. The deviation leads to lower image quality. The use of a structure in which the first portions 41B and the second portions 41R are separated from each other is less likely to cause lower image quality due to overlapping of the first portions 41B and the second portions 41R. In such a configuration, external light is more likely to be incident on the second major surface S2, allowing the display body 1A to display a brighter image. In order to obtain these effects, the distance between adjacent ones of the first portions 41B and the second portions 41R is preferably 3 μm or more, and more preferably 5 μm or more.

However, a large distance between adjacent ones of the first portions 41B and the second portions 41R, for example, greater than 15 μm leads to small areas of the regions of the first portions 41B and the second portions 41R observable through the light transmitting portions 32. This causes the display body 1A to display an image with low saturation. From this viewpoint, the distance between adjacent ones of the first portions 41B and the second portions 41R is preferably 15 μm or less, and more preferably 10 μm or less.

Adjacent ones of the first portions 41B and the second portions 41R may be in contact with each other. Such a configuration can achieve the highest image quality when the first portions 41B and the second portions 41R can be formed with high shape and dimensional accuracy.

Each of a width W_{B} of the first portions 41B and a width W_{R} of the second portions 41R is preferably 50% or less of the pitch P_{T}, and more preferably 45% or less of the pitch P_{T}. Each of the width W_{B} and the width W_{R} is preferably 30% or more of the pitch P_{T}, and more preferably 35% or more of the pitch P_{T}. When the ratio of each of the width W_{B} and the width W_{R} to the pitch P_{T} is high, for example, the display body 1A can display an image with high saturation in a larger observation angle range.

A ratio S1/S2 between a total area S1 of the first regions of all the first portions 41B and the second portions 41R and a total area S2 of the light transmitting portions 32 is preferably in the range of 10% to 100%. In one example, the ratio S1/S2 is preferably in the range of 70% to 100%, and more preferably in the range of 85% to 100%. In another example, the ratio S1/S2 is preferably in the range of 10% to 60%, and more preferably in the range of 15% to 40%. When the ratio S1/S2 is high, for example, in the range of 85% to 100%, for example, the display body 1A can display an image with high saturation as observed from the first direction. On the other hand, for example, in an integrated object obtained by sandwiching the display body 1A between a pair of substrates, a low ratio S1/S2, for example, in the range of 10 to 60% leads to high adhesion between the substrate on the rear surface side and the display body 1A, and facilitates visual recognition of an image recorded on the substrate on the rear surface side in regions corresponding to the portions of the mask layer 3 in which the light transmitting portions 32 are provided. The ratio S1/S2 here is a ratio (W_{B}1+W_{R}1)/W_{T} of a sum W_{B}1+W_{R}1 of a width W_{B}1 and a width W_{R}1 to the width W_{T}, where W_{B}1 is the width of the one or more first regions of the first portions 41B and W_{R}1 is the width of the one or more first regions of the second portions 41R.

A ratio W_{B}2/T between a width W_{B}2 of the one or more second regions of the first portions 41B and the thickness T of the transparent material layer 2 is preferably in the range of 0.3 to 1.4, and more preferably in the range of 0.8 to 1.0. A ratio W_{R}2/T between a width W_{R}2 of the one or more second regions of the second portions 41R and the thickness T of the transparent material layer 2 is also preferably in the range described above for the ratio W_{B}2/T. When the ratio W_{B}2/T or the ratio W_{R}2/T is high, for example, greater than 1.4, in an image displayed by the display body 1A, small color variation occurs according to a change in observation direction. When the ratio W_{B}2/T or the ratio W_{R}2/T is low, for example, from 0.3 to 1.0, the display body 1A can display an image with high saturation in a smaller observation angle range.

The thickness of the layers of the image display layer is, for example, in the range of 0.1 to 10 μm. The thickness of the layers is preferably 0.2 μm or more.

The mask portions 31, the first portions 41B, and the second portions 41R can be formed, for example, by printing. The printing may be, for example, screen printing, screen offset printing, gravure printing, gravure offset printing, or flexographic printing.

The printing may be performed, for example, using a general-purpose color ink. The ink used in the printing contains, for example, a resin and a pigment.

The resin in the ink may be, for example, a general-purpose resin such as a vinyl chloride resin, an acrylic resin, a polyurethane resin, a polyester resin, an epoxy resin, a nitrocellulose resin, an ethyl cellulose resin, a polyamide resin, a phenol resin, a ketone resin, a maleic acid resin, or a photocurable resin.

The pigment in the ink may be metal; an oxide, examples of which include titanium dioxide, zinc white, and iron black; a hydroxide; a sulfide; a selenide; cobalt aluminate; a ferrocyanide; a chromate; a sulfate; a carbonate; a silicate; a phosphate; or carbon. Examples of an organic pigment include a carbon compound, a nitroso compound, a nitro compound, an azo compound, a lake dye, a phthalocyanine compound, and a condensed polycyclic material.

As a pigment in the ink, light scattering particles may be used. The material of the light scattering particles may be, for example, an acrylic resin, polystyrene, a styrene-acrylic copolymer or a cross-linked product thereof, a melamine-formalin condensate, a urethane resin, polyester, a silicone resin, a fluororesin, an epoxy resin, or a copolymer thereof. As light scattering particles, an inorganic material may be used. An inorganic material that can be used as light scattering particles is, for example, a clay compound such as smectite, kaolinite, or talc; an inorganic oxide such as silica, titania, alumina, silica alumina, zirconia, zinc oxide, barium oxide, or strontium oxide; an inorganic carbonate such as calcium carbonate, barium carbonate, magnesium carbonate, or strontium carbonate; an inorganic chloride such as barium chloride or strontium chloride; an inorganic sulfate such as barium sulfate or strontium sulfate; an inorganic nitrate such as barium nitrate or strontium nitrate; an inorganic hydroxide such as barium hydroxide, aluminum hydroxide, or strontium hydroxide; or glass.

The ink may further contain a solvent. The solvent may be, for example, a hydrocarbon solvent such as petroleum naphtha, toluene, xylene, tetralin, or turpentine oil; an ester solvent such as n-butyl acetate or methoxybutyl acetate; a ketone solvent such as methyl isobutyl ketone (MIBK), diacetone alcohol, cyclohexanone, or isophorone; a polyhydric alcohol derivative such as methyl cellosolve, ethyl cellosolve, butyl cellosolve, cellosolve acetate, butyl cellosolve acetate, or butyl carbitol; or a mixture thereof.

The ink may further contain an additive. The additive may be, for example, a vegetable oil, a surfactant, a wax swelling agent, an antifoaming agent, a leveling agent, a slip agent, an ultraviolet absorber, a plasticizer, a curing accelerator, or a mixture thereof.

The display body 1A may further include one or more protective layers. For example, the display body 1A may further include a protective layer provided on the first major surface S1 via the mask layer 3. Alternatively, the display body 1A may further include a protective layer provided on the second major surface S2 via the image display layer. Alternatively, the display body 1A may further include both of these protective layers.

The one or more protective layers are transparent to light in the visible range. The one or more protective layers are preferably colorless and transparent. The one or more protective layers may be a sheet or a film. The one or more protective layers may be, for example, a polymer sheet or a polymer film. The one or more protective layers may have a single-layer structure or a multilayer structure.

The material of the one or more protective layers may be, for example, a photocurable resin such as a polycarbonate resin, an acrylic resin, a fluorine acrylic resin, a silicone acrylic resin, an epoxy acrylate resin, a polystyrene resin, a cycloolefin polymer, a methylstyrene resin, a fluorene resin, polyethylene terephthalate (PET), or polypropylene; a thermosetting resin such as an acrylonitrile-styrene copolymer resin, a phenol resin, a melamine resin, a urea resin, or an alkyd resin; or a thermoplastic resin such as a polypropylene resin, a polyethylene terephthalate resin, or a polyacetal resin.

As described below, the color of an image displayed by the display body 1A can be varied according to a change in observation direction. Here, the surface of the display body 1A on the image display layer side is illuminated with white light, and the surface of the display body 1A on the mask layer 3 side is observed.

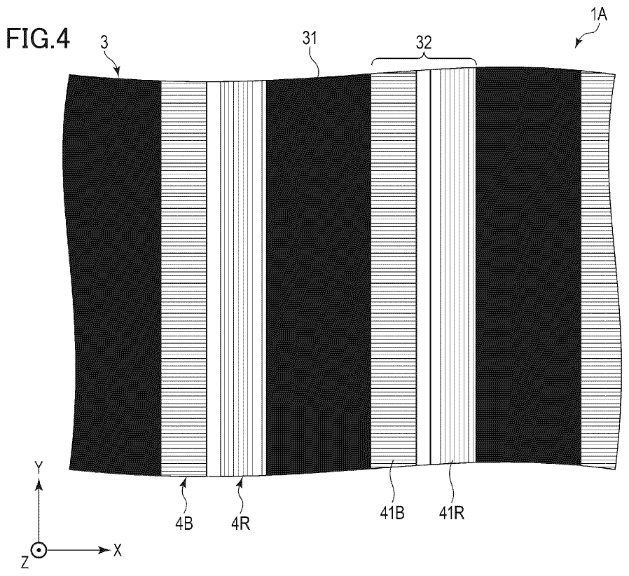

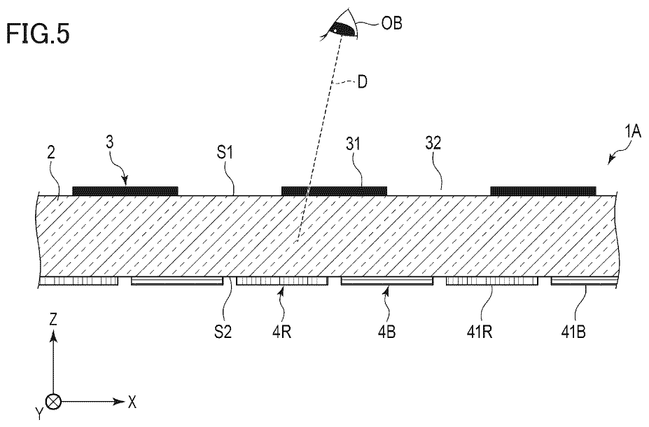

FIG. 3 is a schematic diagram illustrating a state in which an image displayed by the display body shown in FIGS. 1 and 2 under a given observation condition is observed by an observer OB. FIG. 4 is an enlarged view of the image displayed by the display body in FIGS. 1 and 2 under the observation condition in FIG. 3.

In the observation condition shown in FIG. 3, an observation direction D that is a direction in which the display body 1A is observed by an observer OB is the first direction, that is, the Z direction. In this observation condition, as shown in FIG. 4, partial regions of the first portions 41B and the second portions 41R are concealed by the mask portions 31, and the remaining regions are visible through the light transmitting portions 32 at the positions of the light transmitting portions 32. Therefore, the color of an image displayed by the display body 1A at the positions at which the mask portions 31 overlap with the image display layer is a color obtained by mixing the color of the mask portions 31, the color of the first portions 41B, and the color of the second portions 41R. Here, the color of the mask portions 31 is black, the color of the first portions 41B is blue, and the color of the second portions 41R is red, and thus the color of the image is dark purple.

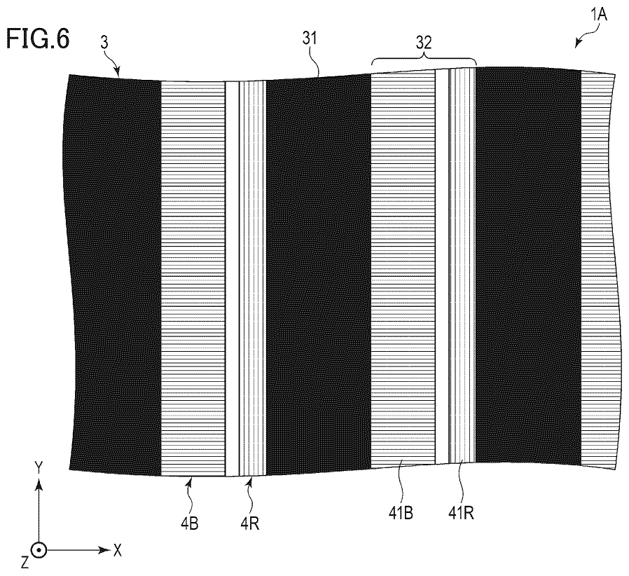

FIG. 5 is a schematic diagram illustrating a state in which an image displayed by the display body shown in FIGS. 1 and 2 under another observation condition is observed by an observer. FIG. 6 is an enlarged view of the image displayed by the display body in FIGS. 1 and 2 under the observation condition in FIG. 5.

In the observation condition shown in FIG. 5, the observation direction D is a direction that is perpendicular to the Y direction and is inclined toward the positive side with respect to the Z direction. The angle formed by the observation direction D with respect to the Z direction is smaller than the angle formed by a second direction (described later) with respect to the Z direction. In this observation condition, as shown in FIG. 6, as compared with the observation condition described with reference to FIGS. 3 and 4, smaller regions of the first portions 41B are concealed by the mask portions 31, and larger regions of the first portions 41B are visible through the light transmitting portions 32 at the positions of the light transmitting portions 32. Furthermore, in this observation condition, as compared with the observation condition described with reference to FIGS. 3 and 4, larger regions of the second portions 41R are concealed by the mask portions 31, and smaller regions of the second portions 41R are visible through the light transmitting portions 32 at the positions of the light transmitting portions 32. Therefore, in this observation condition, as compared with the observation condition described with reference to FIGS. 3 and 4, the color of an image displayed by the display body 1A at the positions at which the mask portions 31 overlap with the image display layer is more influenced by the first portions 41B and less influenced by the second portions 41R. Here, the color of the mask portions 31 is black, the color of the first portions 41B is blue, and the color of the second portions 41R is red, and thus the color of the image is dark purple with stronger blue and weaker red.

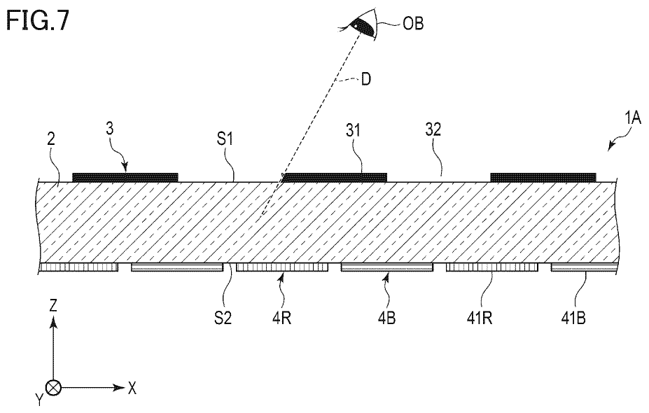

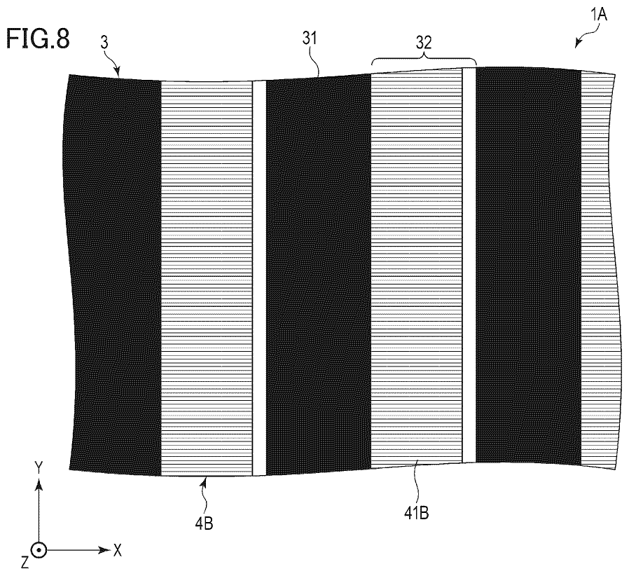

FIG. 7 is a schematic diagram illustrating a state in which an image displayed by the display body shown in FIGS. 1 and 2 under still another observation condition is observed by an observer. FIG. 8 is an enlarged view of the image displayed by the display body in FIGS. 1 and 2 under the observation condition in FIG. 7.

In the observation condition shown in FIG. 7, the observation direction D is the second direction. The second direction is a direction that is perpendicular to the Y direction and is inclined toward the positive side with respect to the Z direction. The angle formed by the observation direction D or the second direction with respect to the Z direction is larger than the angle formed by the observation direction D with respect to the Z direction in the observation condition described with reference to FIG. 5. In this observation condition, as shown in FIG. 8, the second portions 41R are concealed by the mask portions 31, and only the first portions 41B are visible through the light transmitting portions 32 at the positions of the light transmitting portions 32. Therefore, the color of an image displayed by the display body 1A at the positions at which the mask portions 31 overlap with the image display layer is a color obtained by mixing the color of the mask portions 31 and the color of the first portions 41B. Here, the color of the mask portions 31 is black, and the color of the first portions 41B is blue, and thus the color of the image is dark blue.

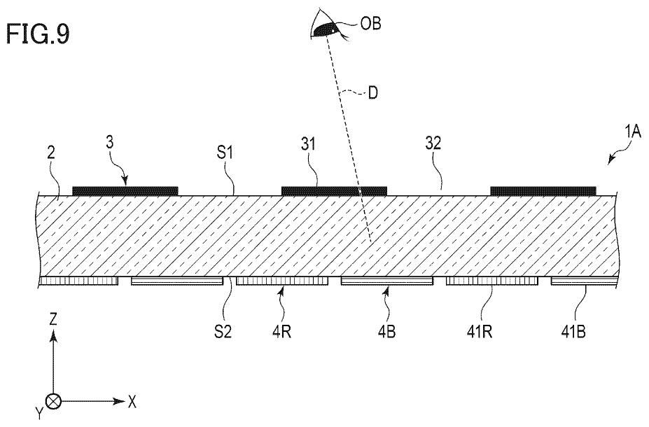

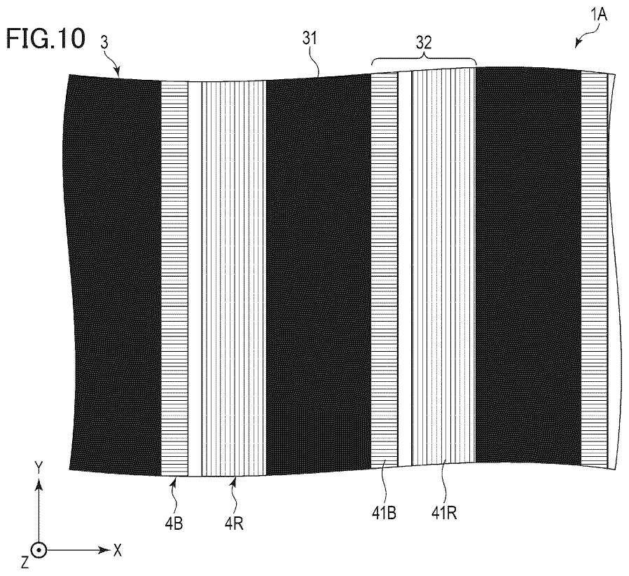

FIG. 9 is a schematic diagram illustrating a state in which an image displayed by the display body shown in FIGS. 1 and 2 under still another observation condition is observed by an observer OB. FIG. 10 is an enlarged view of the image displayed by the display body in FIGS. 1 and 2 under the observation condition in FIG. 9.

In the observation condition shown in FIG. 9, the observation direction D is a direction that is perpendicular to the Y direction and is inclined toward the negative side with respect to the Z direction. The angle formed by the observation direction D with respect to the Z direction is smaller than the angle formed by a third direction (described later) with respect to the Z direction. In this observation condition, larger regions of the first portions 41B are concealed by the mask portions 31, and smaller regions of the first portions 41B are visible through the light transmitting portions 32 at the positions of the light transmitting portions 32. Furthermore, in this observation condition, as compared with the observation condition described with reference to FIGS. 3 and 4, smaller regions of the second portions 41R are concealed by the mask portions 31, and larger regions of the second portions 41R are visible through the light transmitting portions 32 at the positions of the light transmitting portions 32. Therefore, in this observation condition, as compared with the observation condition described with reference to FIGS. 3 and 4, the color of an image displayed by the display body 1A at the positions at which the mask portions 31 overlap with the image display layer is less influenced by the first portions 41B and more influenced by the second portions 41R. Here, the color of the mask portions 31 is black, the color of the first portions 41B is blue, and the color of the second portions 41R is red, and thus the color of the image is dark purple with weaker blue and stronger red.

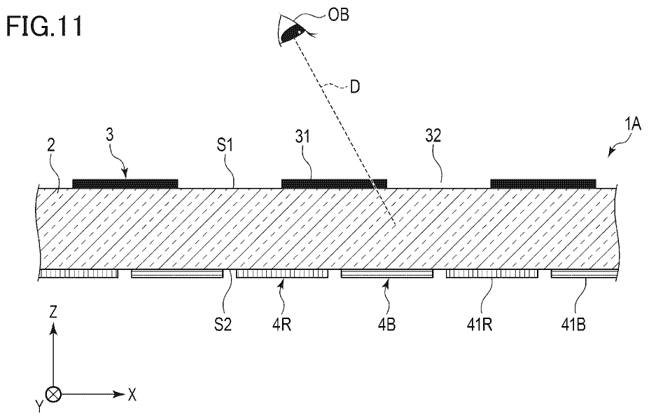

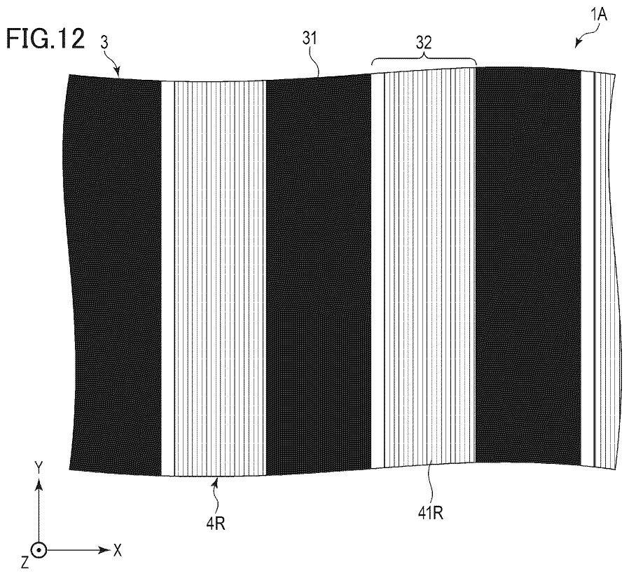

FIG. 11 is a schematic diagram illustrating a state in which an image displayed by the display body shown in FIGS. 1 and 2 under still another observation condition is observed by an observer OB. FIG. 12 is an enlarged view of the image displayed by the display body in FIGS. 1 and 2 under the observation condition in FIG. 11.

In the observation condition shown in FIG. 11, the observation direction D is the third direction. The third direction is a direction that is perpendicular to the Y direction and is inclined toward the negative side with respect to the Z direction. The angle formed by the observation direction D or the third direction with respect to the Z direction is larger than the angle formed by the observation direction D with respect to the Z direction in the observation condition described with reference to FIG. 9. In this observation condition, as shown in FIG. 12, the first portions 41B are concealed by the mask portions 31, and only the second portions 41R are visible through the light transmitting portions 32 at the positions of the light transmitting portions 32. Therefore, the color of an image displayed by the display body 1A at the positions at which the mask portions 31 overlap with the image display layer is a color obtained by mixing the color of the mask portions 31 and the color of the second portions 41R. Here, the color of the mask portions 31 is black, and the color of the second portions 41R is red, and thus the color of the image is dark red.

As described above, in the display body 1A, even when an optically variable ink is not used in the mask layer 3 or the layers of the image display layer, the color of an image can be varied according to a change in the observation direction. Therefore, there is no restriction on a pigment that can be used, and for example, it is possible to obtain color variation that cannot be achieved by an optically variable ink. Thus, the technique described above for the display body 1A enables special image display.

When the observer OB attempts to check color variation in an image displayed by the display body 1A, usually, the observation direction D is first set to a substantially normal direction, and then the observation direction D is inclined. In a display body having the same structure as the display body 1A except that the first portions 41B and the second portions 41R are arranged so that the positions of the center lines of the first portions 41B coincide with the positions of the center lines of the light transmitting portions 32, gap regions are present between the first portions 41B and the second portions 41R; thus, the color of an image is not varied by setting the observation direction D to a substantially normal direction and then causing the observation direction D to be slightly inclined from the substantially normal direction. Therefore, in an image displayed by such a display body, discontinuous color variation occurs according to a change in the observation direction.

On the other hand, the color of an image displayed by the display body 1A is varied by causing the observation direction D to be slightly inclined from the normal direction. The color of the image is continuously varied according to a change in the observation direction D.

### Second Embodiment

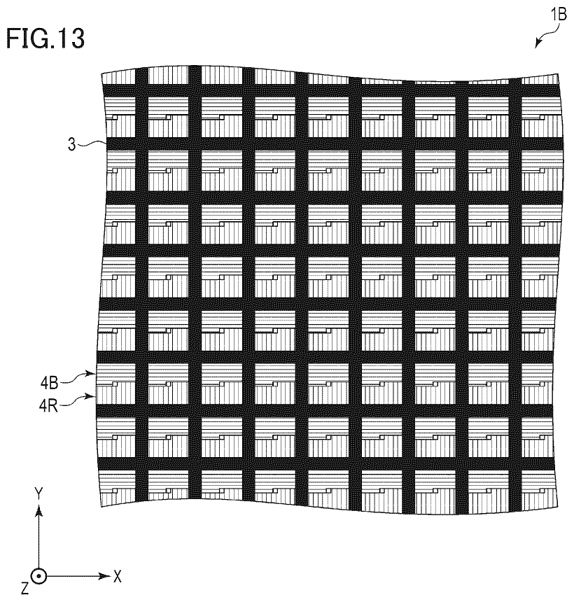

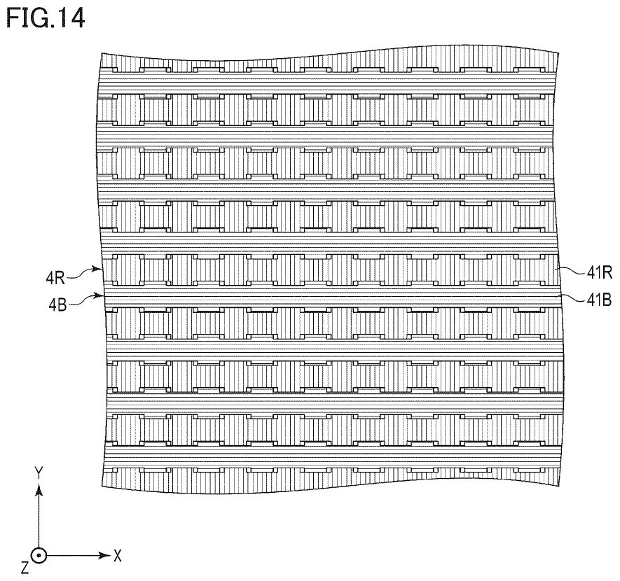

FIG. 13 is an enlarged view of an image displayed by a display body according to a second embodiment of the present disclosure under a given observation condition. FIG. 14 is a diagram illustrating a structure obtained by omitting a mask layer from the display body in FIG. 13.

A display body 1B shown in FIG. 13 is the same as the display body 1A except that the mask layer 3 and the image display layer have the following structures.

In the display body 1B, portions of the mask layer 3 in which the light transmitting portions are provided, i.e., the mask portions 31 here, are arranged in a grid pattern instead of a stripe pattern. Each of the light transmitting portions of the mask layer 3 has a square shape or a rectangular shape. The light transmitting portions of the mask layer 3 are arranged in the X direction and the Y direction.

In the display body 1B, the image display layer has the structure shown in FIG. 14.

The first portions 41B each have a shape extending in the X direction, and are arranged in the Y direction. One side along the longitudinal direction of each of the first portions 41B has a wavy shape. The first portions 41B here each have a shape in which first cross portions and first connecting portions are alternately and continuously arranged in the X direction, and the first portions 41B are arranged in the Y direction.

The second portions 41R each have a shape extending in the X direction, and are alternately arranged with the first portions 41B in the Y direction. One side along the longitudinal direction of each of the second portions 41R has a wavy shape. The second portions 41R here each have a shape in which second cross portions and second connecting portions are alternately and continuously arranged in the X direction, and the second portions 41R are arranged with the first portions 41B in the Y direction so that each of the second connecting portions is located between adjacent ones of the first cross portions in the Y direction.

In the image display layer, the first portions 41B and the second portions 41R have gap regions between first cross portions and second cross portions adjacent to each other in a direction inclined with respect to the X direction. The first portions 41B and the second portions 41R are arranged so that the positions of some of the gap regions coincide with the positions of the centers of the light transmitting portions and the positions of the remaining gap regions overlap with the positions of the mask portions 31.

As described above, in an image displayed by the display body 1A at the positions at which the mask portions 31 overlap with the image display layer, color variation occurs when the observation direction is changed in a plane perpendicular to the Y direction. However, when the observation direction is changed in a plane perpendicular to the X direction, no color variation occurs in the image displayed by display body 1A.

On the other hand, in an image displayed by the display body 1B at the positions at which the mask portions 31 overlap with the image display layer, color variation occurs when the observation direction is changed to any direction. Thus, the technique described above for the display body 1B enables more special image display.

As in the display body 1A, the color of an image displayed by the display body 1B is varied by causing the observation direction D to be slightly inclined from the normal direction. The color of the image is continuously varied according to a change in the observation direction D.

### Third Embodiment

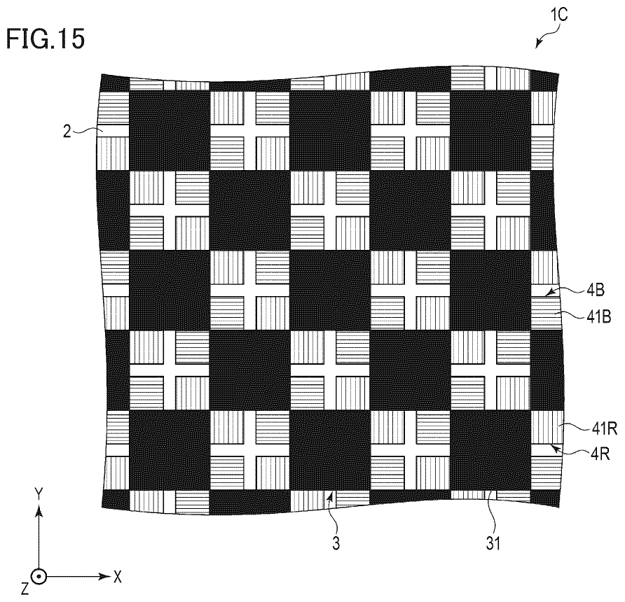

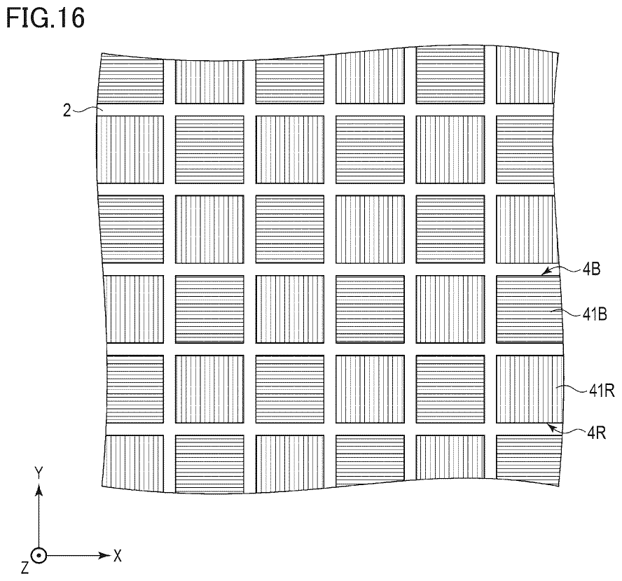

FIG. 15 is an enlarged view of an image displayed by a display body according to a third embodiment of the present disclosure under a given observation condition. FIG. 16 is a diagram illustrating a structure obtained by omitting a mask layer from the display body in FIG. 15.

A display body 1C shown in FIG. 15 is the same as the display body 1A except that the mask layer 3 and the image display layer have the following structures.

In the display body 1C, portions of the mask layer 3 in which the light transmitting portions are provided, i.e., the mask portions 31, are arranged in a checkerboard pattern instead of a stripe pattern. Each of the light transmitting portions of the mask layer 3 has a square shape or a rectangular shape.

In the display body 1C, the image display layer has the structure shown in FIG. 16.

The first portions 41B and the second portions 41R each have a square shape or a rectangular shape, and are alternately arranged in each of the X direction and the Y direction. The arrangement pitches of the first portions 41B in the X direction and the Y direction are the same as the arrangement pitches of the mask portions 31 in the X direction and the Y direction, respectively. Boundary regions extending in the X direction and boundary regions extending in the Y direction are interposed between the first portions 41B and the second portions 41R. An intersection portion of boundary regions faces the center of one of the mask portions 31 of the mask layer 3 or the center of one of the light transmitting portions.

In an image displayed by the display body 1A, color variation occurs when the observation direction is inclined in a plane perpendicular to the Y direction. On the other hand, in an image displayed by the display body 1C, color variation occurs when the observation direction is inclined in a plane perpendicular to a direction that is perpendicular to the Z direction and obliquely intersects the Y direction, for example, in a plane perpendicular to a direction that forms an angle of 90° with respect to the Z direction and an angle of 45° with respect to the Y direction.

An image displayed by the display body 1A when the observation direction is inclined toward the positive side in a plane perpendicular to the Y direction is different in color from an image displayed by the display body 1A when the observation direction is inclined toward the negative side in the plane. On the other hand, an image displayed by the display body 1C when the observation direction is inclined toward the positive side in a plane perpendicular to a direction that is perpendicular to the Z direction and obliquely intersects the Y direction is the same color as an image displayed by the display body 1C when the observation direction is inclined toward the negative side in the plane. Furthermore, for example, an image displayed by the display body 1C when the observation direction is inclined in a first plane perpendicular to a direction that forms an angle of 90° with respect to the Z direction and an angle of 45° with respect to the Y direction is different in color from an image displayed by the display body 1C when the observation direction is inclined in a second plane that is perpendicular to the first plane and parallel to the Z direction.

Thus, the technique described above for the display body 1C enables more special image display. As in the display body 1A, the color of an image displayed by the display body 1C is varied by causing the observation direction D to be slightly inclined from the normal direction. The color of the image is continuously varied according to a change in the observation direction D.

### Fourth Embodiment

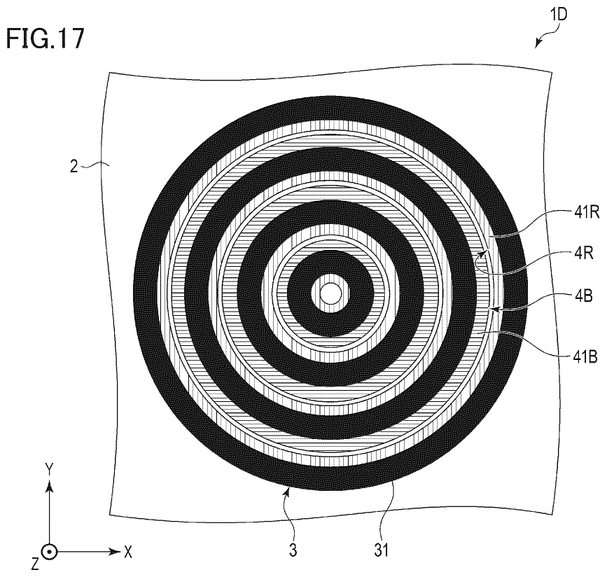

FIG. 17 is an enlarged view of an image displayed by a display body according to a fourth embodiment of the present disclosure under a given observation condition. FIG. 18 is a diagram illustrating a structure obtained by omitting a mask layer from the display body in FIG. 17.

A display body 1D shown in FIG. 17 is the same as the display body 1A except that the mask layer 3 and the image display layer have the following structures.

In the display body 1D, the light transmitting portions of the mask layer 3 each have a strip shape, and are regularly arranged in a nested manner in the width direction. More specifically, portions of the mask layer 3 in which the light transmitting portions are provided, i.e., the mask portions 31 here, are arranged in a concentric pattern instead of a stripe pattern.

In the display body 1D, the image display layer has the structure shown in FIG. 18.

The first portions 41B each have a strip shape, and are regularly arranged in a nested manner in the width direction. More specifically, the first portions 41B are arranged in a concentric pattern. A region along the outer circumference of each of the first portions 41B faces one of the light transmitting portions of the mask layer 3, and a region along the inner circumference of each of the first portions 41B faces one of the mask portions 31 of the mask layer 3.

The second portions 41R each have a strip shape, and are regularly arranged in a nested manner in the width direction. More specifically, the second portions 41R are arranged in a concentric pattern. A region along the inner circumference of each of the second portions 41R faces one of the light transmitting portions of the mask layer 3, and a region along the outer circumference of each of the second portions 41R faces one of the mask portions 31 of the mask layer 3.

The center of the arranged second portions 41R coincides with the center of the arranged first portions 41B. The first portions 41B and the second portions 41R are arranged in a concentric pattern. The first portions 41B and the second portions 41R are alternately arranged outward from the center of the circle. The first portions 41B and the second portions 41R are separated from each other.

When the display body 1D is observed from the first direction that is the normal direction, partial portions of the first portions 41B and the second portions 41R are concealed by the mask portions 31, and the remaining portions of the first portions 41B and the second portions 41R are visible through the light transmitting portions at the positions of the light transmitting portions. Therefore, the color of an image displayed by the display body 1D at the positions at which the mask portions 31 overlap with the image display layer is a color obtained by mixing the color of the mask portions 31, the color of the first portions 41B, and the color of the second portions 41R. Here, the color of the mask portions 31 is black, the color of the first portions 41B is blue, and the color of the second portions 41R is red, and thus the color of the image is dark purple.

For example, in a case where the observation direction is the second direction that is inclined toward the right side in the figure with respect to the normal direction, when the observation direction is inclined with respect to the first direction, for example, when the observation direction is inclined toward the positive side in a plane perpendicular to the Y direction, in a region located on the right of the center of the circle in the figure, the first portions 41B are concealed by the mask portions 31, and only the second portions 41R are visible through the light transmitting portions at the positions of the light transmitting portions. Therefore, the color of an image displayed by the display body 1D in this region is a color obtained by mixing the color of the mask portions 31 and the color of the second portions 41R. Here, the color of the mask portions 31 is black, and the color of the second portions 41R is red, and thus the color of the image is dark red.

When the display body 1D is observed from the second direction, in a region located on the left of the center of the circle in the figure, the second portions 41R are concealed by the mask portions 31, and only the first portions 41B are visible through the light transmitting portions at the positions of the light transmitting portions. Therefore, the color of an image displayed by the display body 1D in this region is a color obtained by mixing the color of the mask portions 31 and the color of the first portions 41B. Here, the color of the mask portions 31 is black, and the color of the first portions 41B is blue, and thus the color of the image is dark blue.

When the display body 1D is observed from the second direction, in a region located above or below the center of the circle in the figure, the color of an image displayed by the display body 1D is the same as the color of an image displayed by the display body 1D in a case where the observation direction is the first direction. That is, the color of the image is dark purple.

As described above, the entire region of an image displayed by the display body 1D at the positions at which the mask portions overlap with the image display layer is in the same color as observed from the first direction. On the other hand, when the observation direction is changed to the second direction, the image displayed by the display body 1D includes regions in different colors. Thus, the technique described above for the display body 1D also enables special image display.

As in the display body 1A, the color of an image displayed by the display body 1D is varied by causing the observation direction D to be slightly inclined from the normal direction. The color of the image is continuously varied according to a change in the observation direction D.

### fifth Embodiment

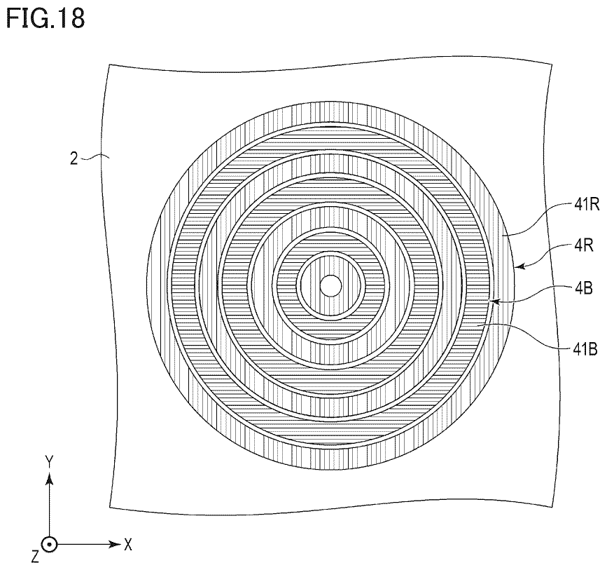

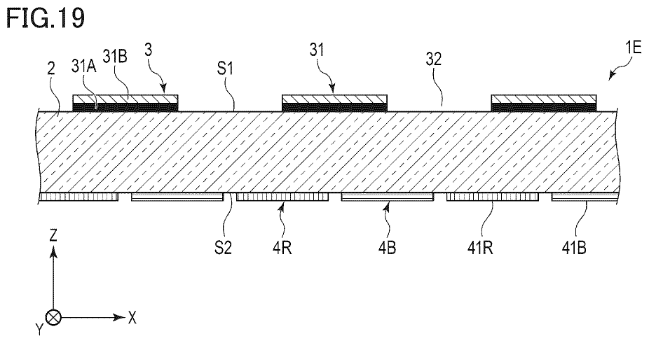

FIG. 19 is a cross-sectional view of a display body according to a fifth embodiment of the present disclosure.

A display body 1E shown in FIG. 19 is the same as the display body 1A except that the mask layer 3 is a laminate including a light shielding layer 31A and a colored layer 31B.

The light shielding layer 31A is selected, for example, from a black layer, a white layer, and a metal layer. The light shielding layer 31A is preferably a white layer or a metal layer. In that case, the display body 1E displays a brighter image as compared with the case where the light shielding layer 31A is a black layer.

The colored layer 31B faces the first major surface S1 via the light shielding layer 31A. The color of the colored layer 31B may be any color. In one example, the colored layer 31B displays a color that can be obtained by mixing the first color displayed by the first layer 4B and the second color displayed by the second layer 4R. In another example, the colored layer 31B displays a color that cannot be obtained by mixing the first color displayed by the first layer 4B and the second color displayed by the second layer 4R.

In the display body 1E, as in the display body 1A, even when an optically variable ink is not used in the mask layer 3 or the layers of the image display layer, the color of an image can be varied according to a change in the observation direction. As in the display body 1A, the color of an image displayed by the display body 1E is varied by causing the observation direction D to be slightly inclined from the normal direction, and the color of the image is continuously varied according to a change in the observation direction D. Furthermore, in the display body 1E, the mask layer 3 includes the light shielding layer 31A and the colored layer 31B; thus, for example, the display body 1E can display a brighter image or an image with higher saturation than the display body 1A.

### Sixth Embodiment

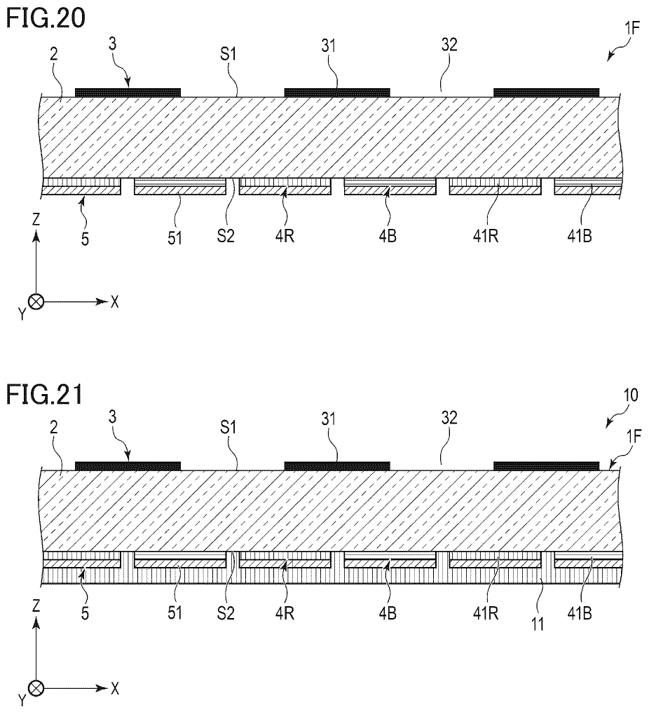

FIG. 20 is a cross-sectional view of a display body according to a sixth embodiment of the present disclosure.

A display body 1F shown in FIG. 20 is the same as the display body 1A except that the display body 1F further includes a rear surface layer 5.

The rear surface layer 5 faces the second major surface S2 via the image display layer. The rear surface layer 5 here is provided on the image display layer. Specifically, the rear surface layer 5 includes a plurality of rear surface portions 51 each of which extends in the Y direction and that are arranged in the X direction. The rear surface portions 51 are provided on the first portions 41B and the second portions 41R of the image display layer.

The rear surface layer 5 may be, for example, a reflective layer. The reflective layer may be, for example, a metal material layer. The reflective layer may be made of an ink containing a light reflecting or light scattering pigment. In that case, the reflective layer contains a light reflecting or light scattering pigment and a resin.

An ink for forming the rear surface layer 5 may be the same as the ink for forming the mask portions 31, the first portions 41B, and the second portions 41R described above, except that the pigment is a light reflecting or light scattering pigment.

The light reflecting or light scattering pigment may be, for example, made of an inorganic material. An inorganic material that can be used in a light reflecting pigment is, for example, a metal such as aluminum, chromium, gold, silver, nickel, or copper, or an alloy thereof. An inorganic material that can be used in a light scattering pigment is, for example, calcium carbonate, barium sulfate, aluminum hydroxide, zinc oxide, lithopone, or titanium oxide. An inorganic material that can be used in a light scattering pigment is a clay compound such as smectite, kaolinite, or talc; an inorganic oxide such as silica, titania, alumina, silica alumina, zirconia, zinc oxide, barium oxide, or strontium oxide; an inorganic carbonate such as calcium carbonate, barium carbonate, magnesium carbonate, or strontium carbonate; an inorganic chloride such as barium chloride or strontium chloride; an inorganic sulfate such as barium sulfate or strontium sulfate; an inorganic nitrate such as barium nitrate or strontium nitrate; an inorganic hydroxide such as barium hydroxide, aluminum hydroxide, or strontium hydroxide; or glass.

The display body 1F preferably satisfies the relationships expressed in Formulas (1) to (5).

Raf1≥20% . . . (1)

Raf2≥20% . . . (2)

Rab≥30% . . . (3)

(Rpf1−Raf1)−(Rpb−Rab)≥10% . . . (4)

(Rpf2−Raf2)−(Rpb−Rab)≥10% . . . (5)

Here, “Rpf1” is the maximum value of the reflectance of the first portions 41B measured in the wavelength range of 400 to 700 nm through the light transmitting portions 32. “Raf1” is the average value of the reflectance of the first portions 41B measured in the wavelength range of 400 to 700 nm through the light transmitting portions 32. “Rpf2” is the maximum value of the reflectance of the second portions 41R measured in the wavelength range of 400 to 700 nm through the light transmitting portions 32. “Raf2” is the average value of the reflectance of the second portions 41R measured in the wavelength range of 400 to 700 nm through the light transmitting portions 32. “Rpb” is the maximum value of the reflectance of the surface of the rear surface layer 5 facing away from the second major surface S2 measured in the wavelength range of 400 to 700 nm. “Rab” is the average value of the reflectance of the surface of the rear surface layer 5 facing away from the second major surface S2 measured in the wavelength range of 400 to 700 nm.

These reflectances are measured using a microspectroscopic reflectance measuring device that can measure reflectance by irradiating a micro region with measurement light.

Specifically, to measure the reflectance of the first portions 41B in the wavelength range of 400 to 700 nm through the light transmitting portions 32, the focus is set on one of the one or more first regions of the first portions 41B overlapping with the light transmitting portions 32, and a region having a diameter smaller than the width of the one of the one or more first regions is irradiated with measurement light. The reflectance is measured at five arbitrary points. The measurement result with the highest average reflectance and the measurement result with the lowest average reflectance are excluded, and the arithmetic mean of the remaining three measurement results is calculated. From the results obtained by calculating the arithmetic mean, the maximum value Rpf1 and the average value Raf1 of the reflectance of the first portions 41B are obtained.

To measure the reflectance of the second portions 41R in the wavelength range of 400 to 700 nm through the light transmitting portions 32, the focus is set on one of the one or more first regions of the second portions 41R overlapping with the light transmitting portions 32, and a region having a diameter smaller than the width of the one of the one or more first regions is irradiated with measurement light. The reflectance is measured at five arbitrary points. The measurement result with the highest average reflectance and the measurement result with the lowest average reflectance are excluded, and the arithmetic mean of the remaining three measurement results is calculated. From the results obtained by calculating the arithmetic mean, the maximum value Rpf2 and the average value Raf2 of the reflectance of the second portions 41R are obtained.

To measure the reflectance of the rear surface layer 5 in the wavelength range of 400 to 700 nm, the focus is set on one of the rear surface portions 51, and a region having a diameter smaller than the width of the one of the rear surface portions 51 is irradiated with measurement light. The reflectance is measured at five arbitrary points. The measurement result with the highest average reflectance and the measurement result with the lowest average reflectance are excluded, and the arithmetic mean of the remaining three measurement results is calculated. From the results obtained by calculating the arithmetic mean, the maximum value Rpb and the average value Rab of the reflectance of the rear surface layer 5 are obtained.

In the display body 1F satisfying the relationships in Formulas (1) and (2), when the front surface is illuminated with white light, the display body 1F exhibits high reflectance at the positions of the first regions of the first portions 41B and the second portions 41R. In the display body 1F satisfying the relationships in Formula (3), the rear surface layer 5 exhibits higher reflectance for white light than a low reflectance surface such as a black surface. In the display body 1F satisfying the relationships in Formulas (4) and (5), color saturation at the positions of the first regions of the first portions 41B and the second portions 41R when the front surface is illuminated with white light is sufficiently higher than color saturation at the position of the rear surface layer 5 when the rear surface is illuminated with white light.

As described above, the thickness of the layers of the image display layer is, for example, 10 μm or less. When the layers are irradiated with visible light in the wavelength range of 400 to 700 nm, the layers transmit a large amount of light and reflect a smaller amount of light than the amount of light transmitted.

Therefore, for example, when the rear surface of the display body 1A is illuminated with white light and the transmitted light is observed, or when the display body 1A is placed on a white surface so that the rear surface of the display body 1A is in contact with the white surface, and the front surface of the display body 1A is illuminated with white light and the reflected light is observed, the display body 1A displays a bright image at the positions at which the light transmitting portions 32 overlap with the image display layer. A bright image is easy to visually recognize. However, when the display body 1A is placed on a low reflectance surface, for example, a black surface, so that the rear surface of the display body 1A is in contact with the black surface, and the front surface of the display body 1A is illuminated with white light and the reflected light is observed, the image displayed by the display body 1A is dark and is thus difficult to visually recognize.

The display body 1F includes the rear surface layer 5. When the front surface of the display body 1F is illuminated with white light, the rear surface layer 5 exhibits higher reflectance for light transmitted through the layers of the image display layer than a low reflectance surface such as a black surface. Therefore, even when the display body 1F is placed on a low reflectance surface, for example, a black surface, so that the rear surface of the display body 1F is in contact with the black surface, and the front surface of the display body 1F is illuminated with white light and the reflected light is observed, the display body 1F displays a bright image at the positions at which the light transmitting portions 32 overlap with the image display layer. That is, the display body 1F can display an image that is easy to visually recognize under more various conditions.

The rear surface layer 5 may be added to the display bodies 1B to 1D. As with the display body 1F, the display bodies 1B to 1D to which the rear surface layer 5 is added can display an image that is easy to visually recognize under more varied conditions.

### Seventh Embodiment

FIG. 21 is a cross-sectional view of a label according to a seventh embodiment of the present disclosure.

A label 10 shown in FIG. 21 includes the display body 1F and an adhesive layer 11. The adhesive layer 11 is supported by the display body 1F. The adhesive layer 11 faces the second major surface S2 via the image display layer and the rear surface layer 5. The adhesive layer 11 may be, for example, made of a thermoplastic resin or an adhesive. The label 10 may further include a peelable sheet provided on the adhesive layer 11.

In a case where the display body 1F is supported by an article, the label 10 including the display body 1F may be prepared and adhered to the article. The label may be a label in which the adhesive layer 11 is supported by any of the display bodies 1A to 1D or by any of the display bodies 1A to 1D to which the rear surface layer 5 is added.

### Eighth Embodiment

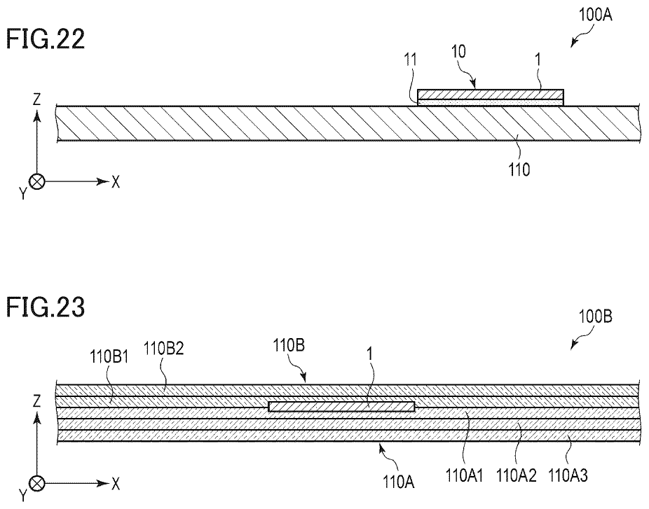

FIG. 22 is a cross-sectional view of an article with a display body according to an eighth embodiment of the present disclosure.

An article with display body 100A shown in FIG. 22 includes the label 10 and an article 110. The label 10 includes a display body 1 and the adhesive layer 11. The display body 1 is any of the display bodies 1A to 1E, any of the display bodies 1A to 1E to which the rear surface layer 5 is added, or the display body 1F. The adhesive layer 11 is supported by the display body 1 to face the second major surface S2 via the image display layer or via the image display layer and the rear surface layer 5. The display body 1 is adhered to the article 110 via the adhesive layer 11. Here, as an example, the display body 1 is assumed to be the display body 1F.

The article 110 supports the display body 1. As described above, the article 110 here has a support surface, and supports the display body 1 via the adhesive layer 11 at the position of the support surface. The article 110 may support the display body 1 by means other than an adhesive.

A color difference ΔE*_{ab} between the mask layer 3 and the support surface is preferably small, for example, 5 or less. In that case, it is difficult to recognize the presence of the mask layer 3, making it difficult to recognize that the display body 1 is adhered to the article 110. Furthermore, in that case, it is easy to recognize variation corresponding to the observation direction in an image displayed by the display body 1 at the positions at which the mask portions 31 overlap with the image display layer.

The colors of the mask layer 3 and the support surface are measured using a micro surface spectral color difference meter that can measure the color of a micro measurement region magnified with a microscope. Specifically, to measure the color of the mask layer 3, the focus is set on a region of one of the mask portions 31 having a diameter smaller than the width of the one of the mask portions 31, and the color of the region is measured. The color is measured at three arbitrary points, and the arithmetic mean of the obtained results is calculated to obtain the color of the mask layer 3. The color of the support surface is obtained in the same manner as described above for the mask layer 3. The color difference ΔE*_{ab} is calculated from the results.

### Ninth Embodiment

FIG. 23 is a cross-sectional view of an article with a display body according to a ninth embodiment of the present disclosure.

An article with display body 100B shown in FIG. 23 includes the display body 1, and an article composed of substrates 110A and 110B. The display body 1 is any of the display bodies 1A to 1E, any of the display bodies 1A to 1E to which the rear surface layer 5 is added, or the display body 1F.

The article composed of the substrates 110A and 110B supports the display body 1. Specifically, the display body 1 is sandwiched between the substrates 110A and 110B so that the substrate 110A is located on the first major surface S1 side of the display body 1 and the substrate 110B is located on the second major surface S2 side of the display body 1, and the substrates 110A and 110B are bonded to each other. In the article, the surface of the substrate 110A on the substrate 110B side serves as a support surface.

The substrate 110A here has a multilayer structure including layers 110A1, 110A2, and 110A3. The substrate 110A may have a two-layer structure, a multilayer structure including four or more layers, or a single-layer structure. The substrate 110A may include an image recording layer such as a printed layer. When the substrate 110A has a multilayer structure including two or more layers, the material of each of the layers may be the same as or different from the material of one or more of the other layers. The layers of the substrate 110A may be, for example, made of resin, metal, paper, glass, ceramic, or a composite material containing two or more of these materials. Here, as an example, each of the layers 110A1, 110A2, and 110A3 is assumed to be a layer made of polycarbonate.

The layers of the substrate 110A may be transparent or opaque. As described above, the surface of the substrate 110A on the substrate 110B side is the support surface. When the layers of the substrate 110A are opaque, the color difference ΔE*_{ab} between the mask layer 3 and the support surface may be in the range described in the eighth embodiment.

The substrate 110B here has a multilayer structure including layers 110B1 and 110B2. At the positions corresponding to the portions of the mask layer 3 in which the light transmitting portions 32 are provided, the layers of the substrate 110B are preferably transparent to visible light, and more preferably transparent. The substrate 110B may have a multilayer structure including three or more layers, or a single-layer structure. When the substrate 110B has a multilayer structure, the material of each of the layers may be the same as or different from the material of one or more of the other layers. The layers of the substrate 110B may be, for example, made of resin, glass, or a composite material containing two or more of these materials. Here, as an example, each of the layers 110B1 and 110B2 is assumed to be a layer made of polycarbonate.

The substrates 110A and 110B can be bonded to each other, for example, by heat sealing or via an adhesive. The layers of the substrate 110A can be bonded to each other, for example, by heat sealing or via an adhesive. The layers of the substrate 110B can be bonded to each other, for example, by heat sealing or via an adhesive.

In the article with display body 100B, the aperture ratio of the portions of the mask layer 3 in which the light transmitting portions 32 are provided is preferably high, for example, in the range of 70% to 90%. In the article with display body 100B, the ratio S1/S2 is preferably low, for example, in the range of 10% to 60%. In that case, it is possible to obtain high adhesion between the substrate 110A and the display body 1 and high adhesion between the substrate 110B and the display body 1. When the substrate 110A includes an image recording layer such as a printed layer, the above configuration facilitates visual recognition of an image recorded on the substrate 110A in regions corresponding to the portions of the mask layer 3 in which the light transmitting portions 32 are provided.

### Tenth Embodiment

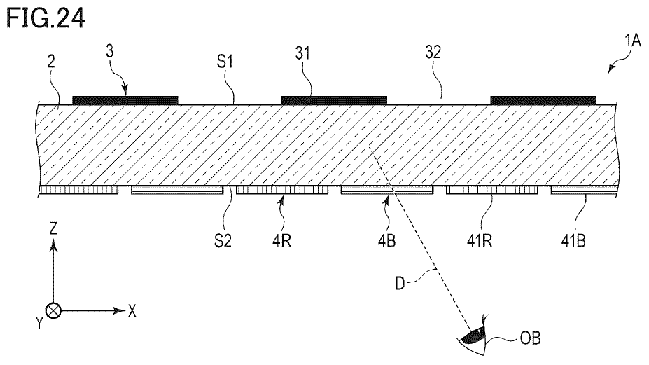

FIG. 24 is a schematic diagram illustrating a state in which an image displayed by a display body according to a tenth embodiment of the present disclosure under a given observation condition is observed by an observer.

The display body 1A shown in FIG. 24 is the same as the display body 1A described in the first embodiment. When an image displayed by the display body 1A is observed, in the first embodiment, the display body 1A is disposed so that the first major surface S1 faces the observer OB; however, in the present embodiment, the display body 1A is disposed so that the second major surface S2 faces the observer OB.

When the surface of the display body 1A on the mask layer 3 side is illuminated with white light and the surface of the display body 1A on the image display layer side is observed, in an image displayed by the display body 1A, a change in the observation direction D causes the same color variation as the color variation described with reference to FIGS. 3 to 12. Thus, in the display bodies 1A to 1D, an observer OB may observe the surface of the display bodies 1A to 1D on the mask layer 3 side or the surface of the display bodies 1A to 1D on the image display layer side. In the display body 1E, an observer OB may observe the surface of the display body 1E on the image display layer side; however, in that case, the light shielding layer 31A and the colored layer 31B are preferably arranged so that the light shielding layer 31A faces the first major surface S1 via the colored layer 31B.

### Modifications

The display body, label, and article with display body described above can be variously modified.

For example, one or more of the first layer 4B, the second layer 4R, and the colored layer 31B may have a multilayer structure. The layers of the multilayer structure may be the same or different in color. The use of a multilayer structure allows color adjustment using the color combination of the layers of the multilayer structure, the number of layers, the thickness of the layers, or the like.

The label 10 may have a structure in which the adhesive layer 11 faces the first major surface S1 via the mask layer 3, instead of a structure in which the adhesive layer 11 faces the second major surface S2 via the image display layer and the like.

In the article with display body 100A, the display body 1 may be supported by the article 110 so that the second major surface S2 faces the article 110 via the adhesive layer 11, the image display layer, and the like.

In the article with display body 100B, the display body 1 may be sandwiched between the substrates 110A and 110B so that the substrate 110B is located on the first major surface S1 side of the display body 1 and the substrate 110A is located on the second major surface S2 side of the display body 1.

### EXAMPLES

### Example 1

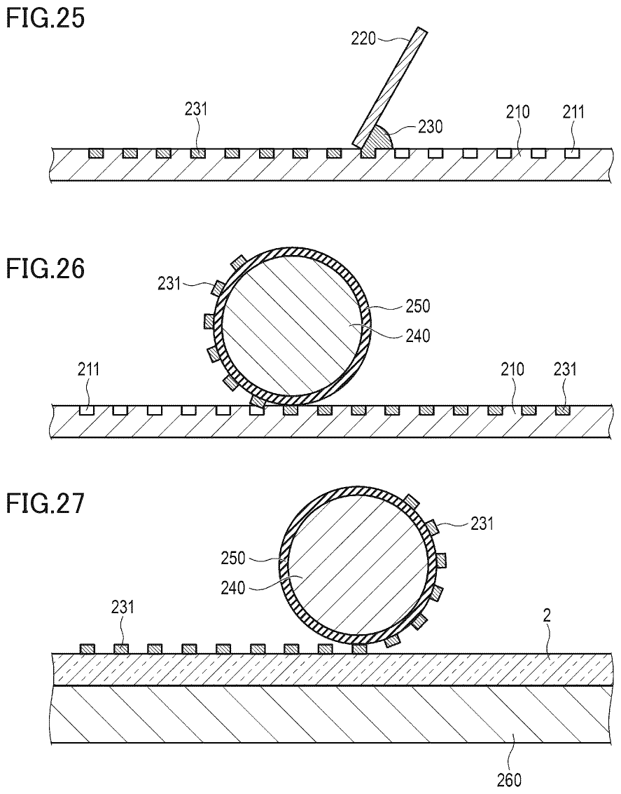

FIG. 25 is a cross-sectional view of a first step of a printing method used in examples. FIG. 26 is a cross-sectional view of a second step of the printing method used in the examples. FIG. 27 is a cross-sectional view of a third step of the printing method used in the examples.

In this example, the display body 1A described with reference to FIGS. 1 and 2 was produced using a gravure offset printing device shown in FIGS. 25 to 27. The gravure offset printing device includes a printing plate 210 that is an intaglio plate, a doctor 220 that fills grooves 211 as recessed portions of the printing plate 210 with an ink 230, a blanket cylinder 240, a blanket 250 that is fixed to a surface of the blanket cylinder 240, and a printing surface plate 260.

A metal flat plate used as a printing plate 210 has a width of 100 mm and a length of 100 mm, and a surface of the metal flat plate has the grooves 211 formed by etching. In a printing plate 210 for forming the mask layer 3, hereinafter may be referred to as a mask layer forming printing plate, the width of the grooves 211 is 50 μm, and the pitch of the grooves 211 is 100 μm. In a printing plate 210 for forming the first layer 4B and the second layer 4R, hereinafter may be referred to as an image display layer forming printing plate, the width of the grooves 211 is 40 μm, and the pitch of the grooves 211 is 100 μm.

The blanket cylinder 240 is made of SUS 304, and has a cylinder width of 220 mm and a diameter of 300 mm.

The blanket 250 is mainly made of silicone rubber, and has a width of 200 mm and a length of 250 mm.

The blanket cylinder 240 is rotatably supported by a movable dolly (not shown). The dolly is supported by a frame. An ink pattern 231 formed by filling the grooves 211 with the ink 230 using the doctor 220 as shown in FIG. 25 is transferred from the printing plate 210 to the blanket 250 fixed to the surface of the blanket cylinder 240 when the blanket cylinder 240 is moved by rolling while the blanket cylinder 240 presses the blanket 250 toward the printing plate 210 as shown in FIG. 26. Then, as shown in FIG. 27, when the blanket cylinder 240 is moved by rolling while the blanket cylinder 240 presses the blanket 250 toward the transparent material layer 2 placed on the printing surface plate 260, the ink pattern 231 is transferred from the blanket 250 to the transparent material layer 2.

In this example, the mask layer 3, the first layer 4B, and the second layer 4R were formed on the transparent material layer 2 using the gravure offset printing device.

The transparent material layer 2 was composed of a polyethylene terephthalate substrate having a width of 150 mm, a length of 150 mm, and a thickness of 0.05 mm. First, the mask layer 3 was formed on one major surface of the transparent material layer 2.

A black gravure offset printing ink was used as an ink for forming the mask layer 3. The mask layer forming printing plate was used as the printing plate 210.

The ink pattern 231 made of a black ink transferred from the blanket 250 onto the transparent material layer 2 was dried by heating at approximately 100 °C for 30 minutes. Thus, the mask layer 3 including the mask portions 31 made of a material obtained by drying the ink pattern 231 was obtained.

Next, the second layer 4R was formed on the surface of the transparent material layer 2 opposite to the surface of the transparent material layer 2 on which the mask layer 3 was formed. A magenta gravure offset printing ink was used as an ink for forming the second layer 4R. The image display layer forming printing plate was used as the printing plate 210. Except for these points, the second layer 4R was formed in the same manner as described above for the mask layer 3. The second layer 4R was formed so that the positions of the center lines of the second portions 41R coincided with the positions of the boundaries between the mask portions 31 and the light transmitting portions 32.

Next, the first layer 4B was formed on the surface of the transparent material layer 2 on which the second layer 4R was formed. A cyan gravure offset printing ink was used as an ink for forming the first layer 4B. The image display layer forming printing plate was used as the printing plate 210. Except for these points, the first layer 4B was formed in the same manner as described above for the mask layer 3. Before the cyan ink was supplied to the printing plate 210, the residual magenta ink on the printing plate 210 was removed using a cleaning liquid and a waste cloth. The first layer 4B was formed so that the positions of the center lines of the first portions 41B coincided with the positions of the boundaries between the mask portions 31 and the light transmitting portions 32.

In the display body 1A obtained in this manner, the mask portions 31 of the mask layer 3 had a width of 50 μm and a thickness of 1.0 μm, and were arranged at a pitch of 100 μm in the width direction. The first portions 41B of the first layer 4B had a width of 40 μm and a thickness of 1.1 μm, and were arranged at the same pitch as the pitch of the mask portions 31 in the width direction. The second portions 41R of the second layer 4R had a width of 40 μm and a thickness of 1.0 μm, and were arranged at the same pitch as the pitch of the mask portions 31 in the width direction.

In the display body 1A, the reflectance was measured using a LVmicro-Z manufactured by Lambda Vision. The diameter of a measurement region here was 15 μm. The results showed that the maximum reflectances Rpf1 and Rpf2 were 28% and 29%, respectively, the average reflectances Raf1 and Raf2 were 8% and 7%, respectively, the maximum reflectance Rpb was 30%, and the average reflectance Rab was 10%. The values calculated by substituting these values in the left side of Formulas (4) and (5) were 0% and 2%, respectively. That is, the display body 1A did not satisfy any of the relationships expressed in Formulas (1) to (5). The display body 1A did not include the rear surface layer 5, and thus the maximum reflectance Rpb and the average reflectance Rab here were obtained by calculating the arithmetic mean of the values for the surfaces of the first portions 41B and the second portions 41R facing away from the second major surface S2.

The surface of the display body 1A on the mask layer 3 side was observed while the surface of the display body 1A on the image display layer side was illuminated with white light and the observation direction was changed in a plane perpendicular to the Y direction. The results showed that the color of the image was greatly varied according to a change in the observation direction. Furthermore, the image displayed by the display body 1A was bright and easy to visually recognize.

The display body 1A was adhered to a black substrate so that the image display layer faced the black substrate. The surface of the display body 1A on the mask layer 3 side was observed while the surface was illuminated with white light and the observation direction was changed in a plane perpendicular to the Y direction. The results showed that the image displayed by the display body 1A was dark and difficult to visually recognize.

### example 2

In this example, the display body 1F described with reference to FIG. 20 was produced. The mask layer 3, the image display layer, and the rear surface layer 5 were formed using the same gravure offset printing device as that used in Example 1.

The transparent material layer 2 was composed of the same polyethylene terephthalate substrate as that used in Example 1. First, the mask layer 3 was formed on one major surface of the transparent material layer 2. The mask layer 3 was formed in the same manner as in Example 1.

Next, the second layer 4R was formed on the surface of the transparent material layer 2 opposite to the surface of the transparent material layer 2 on which the mask layer 3 was formed. The second layer 4R was formed in the same manner as in Example 1.

Subsequently, some of the rear surface portions 51 of the rear surface layer 5 were formed on the second portions 41R of the second layer 4R. A white gravure offset printing ink was used as an ink for forming such rear surface portions 51. The image display layer forming printing plate was used as the printing plate 210. Except for these points, the rear surface portions 51 covering the second portions 41R were formed in the same manner as described above for the mask layer 3.

Next, the first layer 4B was formed on the surface of the transparent material layer 2 on which the second layer 4R and the like were formed. The first layer 4B was formed in the same manner as in Example 1.

Subsequently, the remaining rear surface portions 51 of the rear surface layer 5 were formed on the first portions 41B of the first layer 4B. The same white ink as described above was used as an ink for forming such rear surface portions 51. The image display layer forming printing plate was used as the printing plate 210. Except for these points, the rear surface portions 51 covering the first portions 41B were formed in the same manner as described above for the mask layer 3. Thus, the rear surface layer 5 composed of the rear surface portions 51 covering the first portions 41B and the rear surface portions 51 covering the second portions 41R was obtained.

In the display body 1F obtained in this manner, the mask portions 31 of the mask layer 3 had a width of 80 μm and a thickness of 1.3 μm, and were arranged at a pitch of 160 μm in the width direction. The laminates of the first portions 41B of the first layer 4B and the rear surface portions 51 of the rear surface layer 5 had a width of 70 μm and a thickness of 2.2 μm, and were arranged at the same pitch as the pitch of the mask portions 31 in the width direction. The laminates of the second portions 41R of the second layer 4R and the rear surface portions 51 of the rear surface layer 5 had a width of 70 μm and a thickness of 2.4 μm, and were arranged at the same pitch as the pitch of the mask portions 31 in the width direction.

In the display body 1F, the reflectance was measured using a LVmicro-Z manufactured by Lambda Vision. The diameter of a measurement region here was the same as in Example 1. The results showed that the maximum reflectances Rpf1 and Rpf2 were 39% and 39%, respectively, the average reflectances Raf1 and Raf2 were 23% and 22%, respectively, the maximum reflectance Rpb was 41%, and the average reflectance Rab was 36%. The values calculated by substituting these values in the left side of Formulas (4) and (5) were 11% and 12%, respectively. That is, the display body 1F satisfied the relationships expressed in Formulas (1) to (5).

The surface of the display body 1F on the mask layer 3 side was observed while the surface of the display body 1F on the rear surface layer 5 side was illuminated with white light and the observation direction was changed in a plane perpendicular to the Y direction. The results showed that the color of the image was greatly varied according to a change in the observation direction. Furthermore, the image displayed by the display body 1F was bright and easy to visually recognize.

The display body 1F was adhered to a black substrate so that the rear surface layer 5 faced the black substrate. The surface of the display body 1F on the mask layer 3 side was observed while the surface was illuminated with white light and the observation direction was changed in a plane perpendicular to the Y direction. The results showed that the color of the image was greatly varied according to a change in the observation direction. Furthermore, the image displayed by the display body 1F was bright and easy to visually recognize.

Next, the color of the display body 1F was measured as described above. The color of the display body 1F was measured using a color meter SC-50 μmanufactured by Suga Test Instruments Co., Ltd. The diameter of a measurement region here was 50 μm. The results showed that the color difference ΔE*_{ab} between the mask layer 3 and a support surface that was a surface of the black substrate was 0.9. When the display body 1F and the black substrate to which the display body 1F was adhered were observed with the naked eye under illumination with white light, the display body 1F and the black substrate appeared to be an integrated object.

### example 3

In this example, the display body 1F described with reference to FIG. 20 was produced in the same manner as in Example 2 except for the following point. That is, in this example, instead of a white ink, a silver ink containing silver nanoparticles and a resin was used to form the rear surface layer 5.

In the display body 1F obtained in this manner, the mask portions 31 of the mask layer 3 had a width of 50 μm and a thickness of 1.0 μm, and were arranged at a pitch of 100 μm in the width direction. The laminates of the first portions 41B of the first layer 4B and the rear surface portions 51 of the rear surface layer 5 had a width of 40 μm and a thickness of 2.1 μm, and were arranged at the same pitch as the pitch of the mask portions 31 in the width direction. The laminates of the second portions 41R of the second layer 4R and the rear surface portions 51 of the rear surface layer 5 had a width of 40 μm and a thickness of 2.2 μm, and were arranged at the same pitch as the pitch of the mask portions 31 in the width direction.

In the display body 1F, the reflectance was measured using a LVmicro-Z manufactured by Lambda Vision. The diameter of a measurement region here was the same as in Example 1. The results showed that the maximum reflectances Rpf1 and Rpf2 were 67% and 65%, respectively, the average reflectances Raf1 and Raf2 were 36% and 35%, respectively, the maximum reflectance Rpb was 93%, and the average reflectance Rab was 91%. The values calculated by substituting these values in the left side of Formulas (4) and (5) were 29% and 28%, respectively. That is, the display body 1F satisfied the relationships expressed in Formulas (1) to (5).

The surface of the display body 1F on the mask layer 3 side was observed while the surface of the display body 1F on the rear surface layer 5 side was illuminated with white light and the observation direction was changed in a plane perpendicular to the Y direction. The results showed that the color of the image was greatly varied according to a change in the observation direction. Furthermore, the image displayed by the display body 1F was bright and easy to visually recognize.

The display body 1F was adhered to a black substrate so that the rear surface layer 5 faced the black substrate. The surface of the display body 1F on the mask layer 3 side was observed while the surface was illuminated with white light and the observation direction was changed in a plane perpendicular to the Y direction. The results showed that the color of the image was greatly varied according to a change in the observation direction. Furthermore, the image displayed by the display body 1F was bright and easy to visually recognize.

Next, the color of the display body 1F was measured as described above. The color of the display body 1F was measured using a color meter SC-50 μmanufactured by Suga Test Instruments Co., Ltd. The diameter of a measurement region here was the same as in Example 2. The results showed that the color difference ΔE*_{ab} between the mask layer 3 and a support surface that was a surface of the black substrate was 1.1. When the display body 1F and the black substrate to which the display body 1F was adhered were observed with the naked eye under illumination with white light, the display body 1F and the black substrate appeared to be an integrated object.

### Example 4

In this example, the display body 1F described with reference to FIG. 20 was produced in the same manner as in Example 2 except for the following point. That is, in this example, instead of a black ink, a silver ink containing silver nanoparticles and a resin was used to form the mask layer 3.

In the display body 1F obtained in this manner, the mask portions 31 of the mask layer 3 had a width of 80 μm and a thickness of 1.3 μm, and were arranged at a pitch of 160 μm in the width direction. The laminates of the first portions 41B of the first layer 4B and the rear surface portions 51 of the rear surface layer 5 had a width of 70 μm and a thickness of 2.2 μm, and were arranged at the same pitch as the pitch of the mask portions 31 in the width direction. The laminates of the second portions 41R of the second layer 4R and the rear surface portions 51 of the rear surface layer 5 had a width of 70 μm and a thickness of 2.2 μm, and were arranged at the same pitch as the pitch of the mask portions 31 in the width direction.

In the display body 1F, the reflectance was measured using a LVmicro-Z manufactured by Lambda Vision. The diameter of a measurement region here was the same as in Example 1. The results showed that the maximum reflectances Rpf1 and Rpf2 were 38% and 37%, respectively, the average reflectances Raf1 and Raf2 were 22% and 20%, respectively, the maximum reflectance Rpb was 40%, and the average reflectance Rab was 37%. The values calculated by substituting these values in the left side of Formulas (4) and (5) were 13% and 14%, respectively. That is, the display body 1F satisfied the relationships expressed in Formulas (1) to (5).

The surface of the display body 1F on the mask layer 3 side was observed while the surface of the display body 1F on the rear surface layer 5 side was illuminated with white light and the observation direction was changed in a plane perpendicular to the Y direction. The results showed that the color of the image was greatly varied according to a change in the observation direction. Furthermore, the image displayed by the display body 1F was bright and easy to visually recognize.

The display body 1F was adhered to a silver metal color substrate so that the rear surface layer 5 faced the silver metal color substrate. The surface of the display body 1F on the mask layer 3 side was observed while the surface was illuminated with white light and the observation direction was changed in a plane perpendicular to the Y direction. The results showed that the color of the image was greatly varied according to a change in the observation direction. Furthermore, the image displayed by the display body 1F was bright and easy to visually recognize.

Next, the color of the display body 1F was measured as described above. The color of the display body 1F was measured using a color meter SC-50 μmanufactured by Suga Test Instruments Co., Ltd. The diameter of a measurement region here was the same as in Example 2. The results showed that the color difference ΔE*_{ab} between the mask layer 3 and a support surface that was a surface of the silver metal color substrate was 3.1. When the display body 1F and the silver metal color substrate to which the display body 1F was adhered were observed with the naked eye under illumination with white light, the display body 1F and the silver metal color substrate appeared to be an integrated object.

### Example 5

In this example, the display body 1F described with reference to FIG. 20 was produced in the same manner as in Example 4.

The display body 1F was adhered to a substrate of a metal color different from the silver metal color so that the rear surface layer 5 faced the metal color substrate. The surface of the display body 1F on the mask layer 3 side was observed while the surface was illuminated with white light and the observation direction was changed in a plane perpendicular to the Y direction. The results showed that the color of the image was greatly varied according to a change in the observation direction. Furthermore, the image displayed by the display body 1F was bright and easy to visually recognize.

Next, the color of the display body 1F was measured as described above. The color of the display body 1F was measured using a color meter SC-50 μmanufactured by Suga Test Instruments Co., Ltd. The diameter of a measurement region here was the same as in Example 2. The results showed that the color difference ΔE*_{ab} between the mask layer 3 and a support surface that was a surface of the metal color substrate was 12.5. When the display body 1F and the metal color substrate to which the display body 1F was adhered were observed with the naked eye under illumination with white light, the display body 1F and the metal color substrate were greatly different in color, and it was easy to recognize that the display body 1F was adhered to the metal color substrate.

### Example 6

In this example, the display body 1F described with reference to FIG. 20 was produced in the same manner as in Example 2 except for the following point. That is, in this example, instead of a white ink, a black ink was used to form the rear surface layer 5.

In the display body 1F obtained in this manner, the mask portions 31 of the mask layer 3 had a width of 50 μm and a thickness of 1.1 μm, and were arranged at a pitch of 100 μm in the width direction. The laminates of the first portions 41B of the first layer 4B and the rear surface portions 51 of the rear surface layer 5 had a width of 40 μm and a thickness of 2.3 μm, and were arranged at the same pitch as the pitch of the mask portions 31 in the width direction. The laminates of the second portions 41R of the second layer 4R and the rear surface portions 51 of the rear surface layer 5 had a width of 40 μm and a thickness of 2.2 μm, and were arranged at the same pitch as the pitch of the mask portions 31 in the width direction.

In the display body 1F, the reflectance was measured using a LVmicro-Z manufactured by Lambda Vision. The diameter of a measurement region here was the same as in Example 1. The results showed that the maximum reflectances Rpf1 and Rpf2 were 15% and 13%, respectively, the average reflectances Raf1 and Raf2 were 5% and 4%, respectively, the maximum reflectance Rpb was 4%, and the average reflectance Rab was 3%. The values calculated by substituting these values in the left side of Formulas (4) and (5) were 9% and 8%, respectively. That is, the display body 1F did not satisfy any of the relationships expressed in Formulas (1) to (5).

The surface of the display body 1F on the mask layer 3 side was observed while the surface of the display body 1F on the rear surface layer 5 side was illuminated with white light and the observation direction was changed in a plane perpendicular to the Y direction. The results showed that the color of the image was varied according to a change in the observation direction, but the image displayed by the display body 1F was dark and difficult to visually recognize.

The display body 1F was adhered to a black substrate so that the rear surface layer 5 faced the black substrate. The surface of the display body 1F on the mask layer 3 side was observed while the surface was illuminated with white light and the observation direction was changed in a plane perpendicular to the Y direction. The results showed that the image displayed by the display body 1F was dark and difficult to visually recognize.

Next, the color of the display body 1F was measured as described above. The color of the display body 1F was measured using a color meter SC-50 μmanufactured by Suga Test Instruments Co., Ltd. The diameter of a measurement region here was the same as in Example 2. The results showed that the color difference ΔE*_{ab} between the mask layer 3 and a support surface that was a surface of the black substrate was 1.1. When the display body 1F and the black substrate to which the display body 1F was adhered were observed with the naked eye under illumination with white light, the display body 1F and the black substrate appeared to be an integrated object.

What is claimed is:

1. A display body comprising:
a transparent material layer having a first main surface and a second main surface that is a back surface of the first main surface;
a mask layer provided on the first main surface and having a plurality of regularly arranged light-transmitting portions; and
an image display layer provided on the second main surface,
wherein the image display layer includes a first layer displaying a first color and a second layer displaying a second color different from the first color,
the first layer includes a plurality of first portions arranged in a first arrangement direction of the plurality of light-transmitting portions at the same pitch as a pitch of the plurality of light-transmitting portions in the first arrangement direction,
the second layer includes a plurality of second portions arranged alternately with the plurality of first portions in the first arrangement direction,
the plurality of first portions and the plurality of second portions are spaced apart from each other, and
a ratio W_{B}/P_{T} of a width W_{B} of each of the plurality of first portions to a pitch P_{T} of the arrangement of the plurality of light-transmitting portions, and a ratio W_{R}/P_{T} of a width W_{R} of each of the plurality of second portions to the pitch P_{T} are 45% or less.

2. The display body according to claim 1,
wherein the ratio W_{B}/P_{T} and the ratio W_{R}/P_{T} are in a range of 35% to 45%,
a portion of the mask layer where the plurality of light-transmitting portions are provided has an aperture ratio in a range of 70% to 90%,
a width W_{T} of each of the plurality of light-transmitting portions is 25 μm or more,
each of the plurality of first portions and the plurality of second portions includes:
one or more first regions each observable through one of the plurality of light-transmitting portions when observed from a normal direction perpendicular to the first main surface; and
one or more second regions unobservable through any of the plurality of light-transmitting portions when observed from the normal direction, and
a ratio S1/S2 of a total sum S1 of areas of the first regions for all of the plurality of first portions and the plurality of second portions to a total sum S2 of areas of the plurality of light-transmitting portions is in a range of 70% to 100%.

3. The display body according to claim 1,
wherein a portion of the mask layer where the plurality of light-transmitting portions are provided has an aperture ratio in a range of 80% to 85%,
a width W_{T} of each of the plurality of light-transmitting portions is 25 μm or more,
each of the plurality of first portions and the plurality of second portions includes:
one or more first regions each observable through one of the plurality of light-transmitting portions when observed from a normal direction perpendicular to the first main surface; and
one or more second regions unobservable through any of the plurality of light-transmitting portions when observed from the normal direction, and
a ratio S1/S2 of a total sum S1 of areas of the first regions for all of the plurality of first portions and the plurality of second portions to a total sum S2 of areas of the plurality of light-transmitting portions is in a range of 15% to 40%.

4. The display body according to claim 1,
wherein a portion of the mask layer where the plurality of light-transmitting portions are provided has an aperture ratio in a range of 40% to 70%,
a width W_{T} of each of the plurality of light-transmitting portions is 25 μm or more,
each of the plurality of first portions and the plurality of second portions includes:
one or more first regions each observable through one of the plurality of light-transmitting portions when observed from a normal direction perpendicular to the first main surface; and
one or more second regions unobservable through any of the plurality of light-transmitting portions when observed from the normal direction, and
a ratio S1/S2 of a total sum S1 of areas of the first regions for all of the plurality of first portions and the plurality of second portions to a total sum S2 of areas of the plurality of light-transmitting portions is in a range of 10% to 60%.

5. The display body according to claim 1,
wherein the ratio W_{B}/P_{T} and the ratio W_{R}/P_{T} are in a range of 35% to 45%,
a portion of the mask layer where the plurality of light-transmitting portions are provided has an aperture ratio in a range of 10% to 50%,
a width W_{T} of each of the plurality of light-transmitting portions is in a range of 25 μm to 100 μm,
each of the plurality of first portions and the plurality of second portions includes:
one or more first regions each observable through one of the plurality of light-transmitting portions when observed from a normal direction perpendicular to the first main surface; and
one or more second regions unobservable through any of the plurality of light-transmitting portions when observed from the normal direction, and
a ratio S1/S2 of a total sum S1 of areas of the first regions for all of the plurality of first portions and the plurality of second portions to a total sum S2 of areas of the plurality of light-transmitting portions is in a range of 10% to 40%.

6. The display body according to claim 1,
wherein the ratio W_{B}/P_{T} and the ratio W_{R}/P_{T} are in a range of 35% to 45%,
a portion of the mask layer where the plurality of light-transmitting portions are provided has an aperture ratio in a range of 10% to 50%,
a width W_{T} of each of the plurality of light-transmitting portions is in a range of 25 μm to 100 μm,
each of the plurality of first portions and the plurality of second portions includes:
one or more first regions each observable through one of the plurality of light-transmitting portions when observed from a normal direction perpendicular to the first main surface; and
one or more second regions unobservable through any of the plurality of light-transmitting portions when observed from the normal direction, and
a ratio S1/S2 of a total sum S1 of areas of the first regions for all of the plurality of first portions and the plurality of second portions to a total sum S2 of areas of the plurality of light-transmitting portions is in a range of 15% to 100%.

7. The display body according to claim 1, wherein the mask layer has a light-shielding property.

8. The display body according to claim 1,
wherein each of the plurality of light-transmitting portions has a strip shape, and the plurality of light-transmitting portions are regularly arranged in a width direction, and
each of the plurality of first portions and the plurality of second portions extends in a longitudinal direction of the plurality of light-transmitting portions.

9. The display body according to claim 8, wherein the plurality of light-transmitting portions are arranged in a stripe pattern.

10. The display body according to claim 1, wherein the mask layer includes a light-shielding layer and a colored layer facing the first main surface with the light-shielding layer interposed therebetween.

11. The display body according to claim 1, further comprising a back surface layer facing the second main surface with the image display layer interposed therebetween,
wherein the back surface layer is a reflective layer or is made of an ink containing a light-reflective or light-scattering pigment.

12. The display body according to claim 2, wherein a distance between adjacent ones of the plurality of first portions and the plurality of second portions is in a range of 3 μm to 15 μm.

13. The display body according to claim 2, wherein a thickness of the transparent material layer is in a range of 50 μm to 200 μm.

14. The display body according to claim 1,
wherein each of the plurality of first portions and the plurality of second portions includes:
one or more first regions each observable through one of the plurality of light-transmitting portions when observed from a normal direction perpendicular to the first main surface; and
one or more second regions unobservable through any of the plurality of light-transmitting portions when observed from the normal direction, and
a ratio W_{B}2/T of a width W_{B}2 of each of the one or more second regions to a thickness T of the transparent material layer is in a range of 0.3 to 1.4.

15. An article with a display body, comprising:
the display body according to claim 1; and
an article supporting the display body,
wherein the article has a support surface,
the display body is supported by the article such that the second main surface faces the support surface with the image display layer interposed therebetween, and
a color difference Δ E*_{ab} between the mask layer and the support surface is 5 or less.
